(19) United States
(12) Patent Application Publication
(10) Pub. No.: US 2015/0067061 A1
(43) Pub. Date: Mar. 5, 2015

(54) SYSTEMS AND METHODS FOR PREDICTING AND CHARACTERIZING SOCIAL MEDIA EFFECTIVENESS

(71) Applicant: Milyoni, Inc., Pleasanton, CA (US)

(72) Inventor: Regan Poston, Menlo Park, CA (US)

(21) Appl. No.: 14/475,369

(22) Filed: Sep. 2, 2014

Related U.S. Application Data
(60) Provisional application No. 61/872,153, filed on Aug. 30, 2013.

(51) Int. Cl. H04L 29/08

(52) U.S. Cl. CPC H04L 67/1095; H04L 67/06
USPC 709/204

(57) ABSTRACT

Embodiments of the invention are directed to methods and systems for providing engagements to allow users to interact with reconfigured media inputs being provided through a social media presentation system. User responses, actions, and other related information to the engagements may be collected, analyzed, and actions may be taken based on the analysis. One embodiment may be directed to a method of providing an event scorecard by receiving a user interaction from a user computer, determining an engagement associated with the user interaction, and identifying a type of user interaction and a user identifier. The method continues by storing information associated with the user interaction including the user identifier, the type of user interaction, and a product identifier. The method further includes determining social engagement levels based on stored user interactions, generating event scorecard ratings based on the social engagement levels, and displaying an event scorecard including the scorecard ratings.

### CROSS-REFERENCES TO RELATED APPLICATIONS

This application is a non-provisional of and claims the benefit of priority to U.S. Provisional Application No. 61/872,153, filed Aug. 30, 2013, which is hereby incorporated by reference in its entirety for all purposes.

### BACKGROUND OF THE INVENTION

The present disclosure relates generally to social media interactions and specifically to synchronized media viewing and synchronized media delivery services via social media applications.

The rise of easy networking between computers and computing devices used by multiple people at disparate locations eventually led to the development of online social interaction, social networks and other activities that involve multiple people, typically at more than one physical location with interactions mediated via a network carrying data between clients, servers and nodes associated with various individuals and computers or computing devices.

Social media interactions might include interactions that are mediated by social media services that operate social media servers that connect users, such as the Facebook™ service, the Myspace® service, the LinkedIn® service, the Twitter® service, and other online social-oriented membership and non-membership communities mediated by their respective services.

Generally, these online communities are made up of a plurality of registered users who provide information about themselves (or avatars) that are shared with other members who post information about themselves. Many services can be provided to these users through the social media website including the sharing of information, networking, dating, advertising, and the delivery of media.

As users engage more in social online interactions, there is more demand for more varied interactions. Furthermore, as more users engage in social online interactions there is more demand for media providers to have more control over who is viewing their content and further interacting with users viewing their media inputs. Further, there is a need to better understand, anticipate, predict, and optimize the media inputs, events, and engagements that are provide through social media websites and the internet.

Embodiments of the present invention solve these problems and others, individually and collectively.

### BRIEF SUMMARY OF THE INVENTION

Embodiments of the invention are directed to methods and systems for providing engagements to allow users to interact with reconfigured media inputs being provided through a social media presentation system. User responses, actions, and other related information input in response to the engagements may be collected, analyzed, and actions may be taken based on the analysis.

One embodiment may be directed to a method of providing an event scorecard. The method comprises receiving a user interaction from a user computer, determining an engagement associated with the user interaction, and identifying a type of user interaction and a user identifier associated with the user interaction. The type of user interaction may include an interaction or an expression. The method continues by storing information associated with the user interaction including the user identifier, the type of user interaction, and a product identifier. The method further includes determining a social engagement level for a product associated with an event based on stored user interactions, generating event scorecard ratings based on the social engagement level, and displaying an event scorecard including the event scorecard ratings for the event.

Another embodiment is directed to a method of providing an event scorecard. The method comprises tracking user interactions with a product, determining a social effectiveness of the product associated with the event based on the number of new viewers associated with the product, and determining a user product engagement level associated with the product. The method further comprises determining a universal product engagement level associated with the product and predicting a number of orders associated with the event based on event information, the social effectiveness of the product, and the user product engagement level. The method further comprises calculating an optimized number of orders using event information, the social effectiveness, the user product engagement level, and the universal product engagement level associated with the product. The method continues by determining recommendations for optimizing the predicted number of orders associated with the event and displaying the event scorecard including the recommendations for optimizing the number of orders associated with the event.

Another embodiment is directed to a method of providing an event scorecard. The method comprises tracking user interactions with a product server computer, determining a social engagement level for a product associated with an event, and calculating an optimized number of orders using the social engagement level for the product. The method further comprises determining recommendations for optimizing the number of orders associated with the event and displaying the event scorecard including the recommendations for optimizing the number of orders associated with the event.

Embodiments of the invention are directed to systems, devices, and computer readable media associated with methods described herein. A better understanding of the nature and advantages of the present invention may be gained with reference to the following detailed description and the accompanying drawings.

### BRIEF DESCRIPTION OF THE DRAWINGS

FIG. 1 shows an exemplary flowchart of a general method according to embodiments of the invention.

FIG. 2 shows a block diagram of an exemplary system for delivering reconfigured media content to users through a social media presentation network, according to an embodiment of the invention.

FIG. 3 shows a flowchart for an exemplary method of tracking and collecting user interaction with a social media presentation system operated by a reconfigured media provider, according to an exemplary embodiment of the invention.

FIG. 4 shows a flowchart for a specific example of tracking and collecting user interactions with a social media presentation system operated by a reconfigured media provider, according to an exemplary embodiment of the invention.

FIG. 5 shows a flowchart for analyzing collected user interactions related to a product to determine the social effectiveness and social engagement measurements related to the product, according to an exemplary embodiment of the invention.

FIG. 6 shows an exemplary flowchart for optimizing an event and generating an event social effectiveness scorecard associated with the event, according to an exemplary embodiment of the invention.

FIG. 7 shows an exemplary event social effectiveness scorecard according to an embodiment of the invention.

FIG. 8 shows an exemplary computer system according to an embodiment of the invention.

### DEFINITIONS

Prior to discussing embodiments of the invention, a further description of some terms can be provided for a better understanding of the invention.

A “user” may include any person or entity that interacts with a reconfigured media provider to view or interact with reconfigured media inputs. For example, a user may be a person that is registered to purchase, use, interact with, or view a movie through a social media presentation system. A user may also include a celebrity, moderator, or other designated person that uses the social media presentment system to moderate, operate, direct, or otherwise has a special role outside of merely viewing or interacting with a media input.

A “user identifier” may include any unique identifier for a registered user of the social media presentation system. The user identifier may be provided by a reconfigured media provider, social media network, a user, or any other entity in the social media presentation system. The unique identifier may uniquely identify a user for all purposes within a social media presentation system.

A “reconfigured media provider” may include any entity that incorporates, adds, or otherwise includes non-media inputs associated with a media input for presentation to users.

A “media input” may include a film, song, TV episode, movie trailer, or any other digital media that is provided by a content provider prior to a user's viewing experience. The media inputs can be delivered for educational, entertainment, safety, or any other information sharing purposes. The media input may be a live broadcast (i.e., a live “stream”) or a pre-recorded media event. The media input may be stored at a content delivery network and may be associated with a product stored by the reconfigured media provider.

A “product” may include any media input that is orderable by a user. For example, a product may be a media input that a reconfigured media provider may offer for viewing through a social media presentation system. Products include any media inputs that are provided by the reconfigured media provider that is available for viewing or ordering by a user of the social media presentation system.

An “order” may include any request by a user to view or otherwise interact with a reconfigured media input. A successful order may initiate the delivery of a product including non-media inputs to a user computer, communications with a social media network, and communications with a content delivery network. For example, an order may include a purchase, a free viewing, or any other request to view, interact, or experience a reconfigured media input provided by a reconfigured media provider. Accordingly, orders may be associated with a particular product. Further, each order may have a unique order identifier. Order identifiers include an identifier that is generated for each successful request to view a media input by a user. For example, the order identifier may include an alphanumeric string that is created when a user purchases a ticket to watch a movie, concert, or any other media through the system.

In some embodiments, the order identifier may be used as a user credential or authentication value that the user has permission from the reconfigured media provider to access the requested media input, the user is authorizing the correct media input, etc. For example, the order identifier may be used by the content delivery network to ensure the requesting user has the rights to access the media input stored on the content delivery network.

A “non-media input” may include inputs that are generated by viewers (i.e. users), those experiencing the media, or by the system administrator (e.g. event producer, organizer, etc.) and are not part of the originally generated presentation (e.g. concert, etc.). Non-media inputs could include the actions of a viewer to interact with another viewer or the system before, during, or after the viewing of a media presentation. For example, non-media inputs could include comments made during the viewing of a movie or TV episode that are either shared with another viewer of the presentation or saved at a particular time in the media for later viewing by other users.

An “engagement” is a type of non-media input that may include any data related to a product that is configured to allow a user to engage with the related product. For example, an engagement may include a trivia question, video clip, quote, poll question, etc. Engagements may be generated using engagement data that is associated with a product. Accordingly, every product may have customized engagement data that is generated for the product or for an event associated with the product.

A “feed item” may include data that may be provided to one or more users through a social media presentation system. For example, a feed item may include a chat message that is posted by a user and may be displayed for other users experiencing a product or media input.

A “user computer” may include any device, system, component, or combination thereof that is configured to communicate with one or more service provider computers. For example, a user computer may include a desktop computer, a mobile device, a mobile phone, a tablet, a smartwatch, a phablet, or any other suitable stationary or portable device that is configured to communicate with other devices. The user computer may pass communications through other hardware and may have software operating on the user computer to allow for the functionality described herein.

### DETAILED DESCRIPTION OF THE INVENTION

Embodiments of the present invention are directed to methods and systems for collecting user data as users interact with a social media presentation system, analyzing the user data, and performing a number of actions based on the data analysis.

According to embodiments, a reconfigured media provider may collect user data as user's interact with reconfigured media inputs through the reconfigured media provider. The reconfigured media provider may then predict events, user interest, engagement, success, and other attributes related to media provided through the social media presentation system. Using these predictions, algorithms, and measurements, the reconfigured media provider may determine the most appropriate actions to increase participation, interest, and engagement in a media input.

For example, a reconfigured media provider may be able to tell a media provider the number of viewers they are going to receive for a particular event and actions they can do to increase the numbers of viewers by optimizing an event for users. Accordingly, embodiments of the present invention may identify relevant levers for increasing user participation and interest. For instance, using embodiments of the present invention, the reconfigured media provider may be able to determine that a particular media input or event may have 2,000 users order or pay for the event. Further, the reconfigured media provider may be able to optimize the event details by applying predetermined levers or known event conditions that may increase the number of user orders. Accordingly, once the event details are optimized, the reconfigured media provider may get 8,000 orders instead of 2,000. For example, the reconfigured media provider may change the time for the event from Wednesday at 3:00 pm to Friday at 7:00 pm, may have a lead actor commentate for a live showing, or a particular celebrity may live chat during the showing. The reconfigured media provider may then determine that the above changes would result in up to 8,000 people. Accordingly, embodiments of the present invention collect user data, predict user engagement and media input success, and provide a number of potential actions for increasing user interaction and engagement.

### I. OVERVIEW

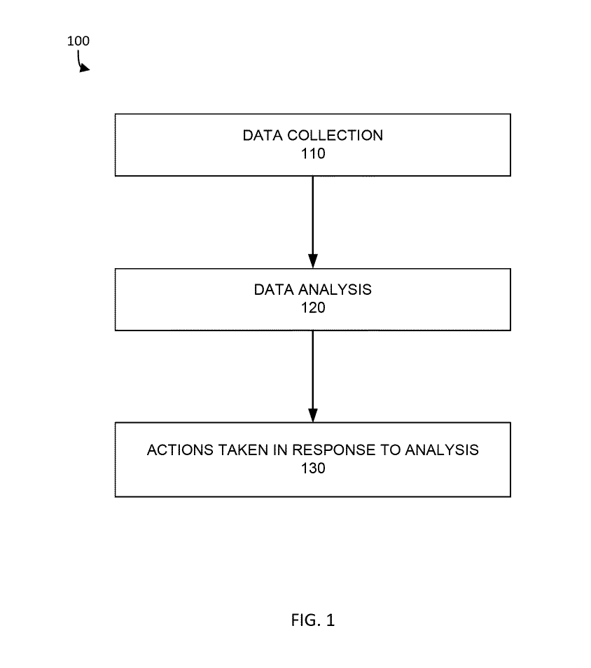

FIG. 1 generally shows, at a high level, a method 100 of measuring the social engagement of users of a social media presentation system, predicting future success for events, and generating an event scorecard, according to embodiments of the present invention. Method 100 may be performed entirely or partially by a computer system, as can other methods described herein.

In step 110, a system may collect data from users. Embodiments may collect social network profile information, data generated from user interactions with non-media inputs and other engagements, and may track the interactions and relationships between users. Methods and system for collecting such data are provided in further detail below.

In step 120, the system may analyze the data. Numerous methods of analysis can be used to answer any number of questions including the effectiveness, efficiency, and results from a media offering. Further, analysis may provide recommendations or actions that may provide for more efficient user interaction, activity, participation (e.g., number of users), or otherwise improve the service provided by the system to users and media providers. The collected data may also be aggregated prior to analysis or may be analyzed individually.

In step 130, may perform an action based on the analysis of the collected data performed above. For example, the system may generate and send communication messages to users based on the determinations made in the previous steps. Additionally, media inputs may be altered, offered by the reconfigured media provider at different times, with different interactive data, or may be offered through an important user or with an important user's recommendation depending on the data analysis of the system. Each of these steps will be described in further detail below.

### II. SYSTEM

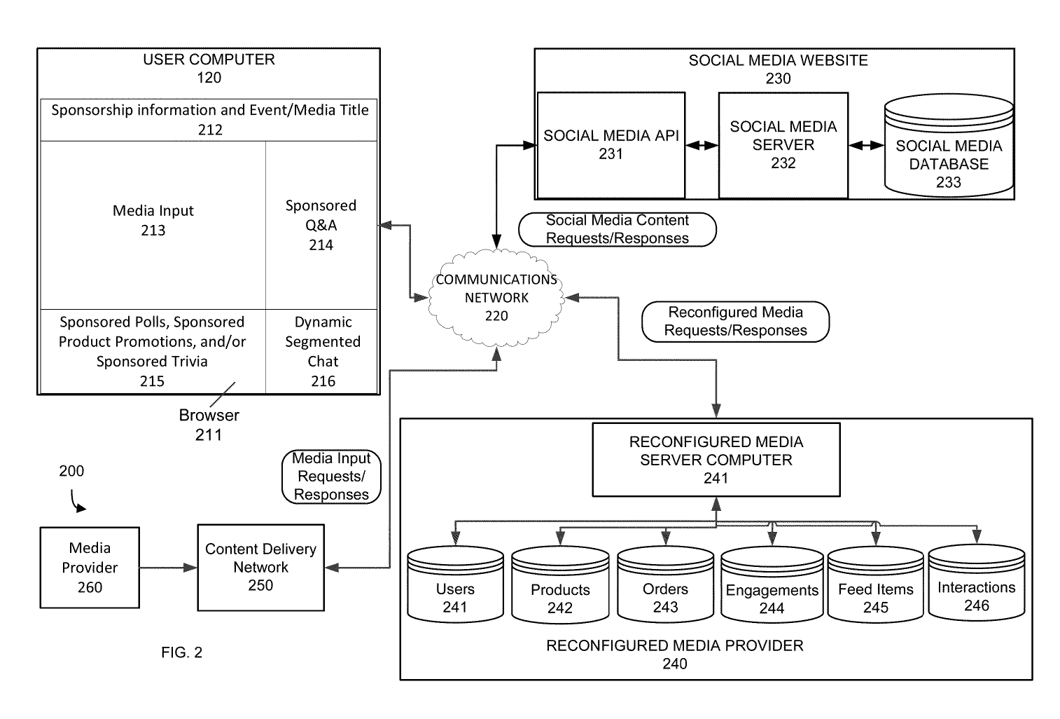

FIG. 2 shows a system 200 for delivering reconfigured media content to users through a social video player provided on a user's browser operating on a user computer, according to one embodiment of the invention. Typically, a media content provider 250 may send a media input to a content delivery network 250 that may reconfigure and store the media for future delivery. The media input may either be an encoded file of a prior performance, recorded video, recorded event, or a live video feed of a performance or event that may be encoded by the content delivery network 250.

A social media presentation system 200 may allow individual users or groups of users to watch a movie, TV show, live concert, or other media event at the same time from different devices in multiple locations. The social media presentation system 200 may allow users to post comments and chat amongst segmented viewers, ask celebrities questions, purchase products or services from advertisers or those products and services that are relevant to the event, participate in polls related to the media viewing experience, take quizzes relevant to the viewing experience, share content related to the media input, or any other interaction with the event. The social media presentation system 200 can provide a virtual theater experience where groups of users can meet on a social media website using their electronic devices at numerous different locations and engage in a social activity centered on the media. Additionally, users may use the system individually to have an interactive experience with any media input to create a community with people of similar interests from around the world.

The content delivery network 250 may use a media application to reconfigure the media input to a format that can be streamed from the content delivery network 250 to user computers 210 that request the media input via a social media website 230 or an independent website managed by the reconfigured media player 240 and delivered by the reconfigured media server computer 241. The reconfigured media provider 240 may also generate non-media inputs (e.g., engagement data) associated with the reconfigured media input so that users of the social media website 230 may interact with the media through the use of sharable clips, quotes, songs, annotated chat, etc. The non-media input options can be added using the social media website's application programming interface (API) 231 as well as through the social video player loaded on the user computer's browser 211. The social video player is delivered by the reconfigured media provider 240 in response to a reconfigured media request (e.g., an order) by a user computer 210.

Once the non-media input is configured, the reconfigured media server 241 may receive an order from a user computer 210 to view the media input or an order from the social media website 230 to stream the media input at a particular scheduled time. The reconfigured media server computer 241 may receive a request for a reconfigured media input, may determine the engagement data or other non-media inputs (e.g., chat stream, etc.) associated with a reconfigured media input, and may send a reconfigured media response to the user computer 210 with the appropriate links, non-media input information, engagements, etc., loaded into the social video player operating on the user computer's browser 211. Accordingly, the user computer 210 may request the media input 213 from the content delivery network 250 along with other non-media inputs from a social media API server 231 at the social media website 230. The social media API server 231 may allow users to interact with each other using the API of each social media website 230 or the reconfigured media provider may generate and use their own APIs to interact with multiple users. Therefore, a different reconfigured media input can be created for different social media websites 230 with different APIs embedded or an independent social media platform may be provided by the reconfigured media provider. Accordingly, the user computer 210 may be delivered the requested media input along with the social features and other non-media inputs (e.g., engagements associated with the media input) designed by the reconfigured media provider 240.

In some embodiments, the reconfigured media provider 240 could also be provided the engagement data from another party (not shown) or the media content provider 260 could configure the non-media inputs prior to providing it to the content delivery network 250 or reconfigured media provider 240.

The social media API server 231 also allows the reconfigured media server 243 access to the user's profile information on the social media database 233 of the social media website 230. The reconfigured media server 243 can also require the user to log in order to determine the user's profile information that is stored by the reconfigured media provider 240 at a user database 241. Finally, the reconfigured media server 243 can create a secure connection or “handshake” with the social media website 230 and deliver the reconfigured media input to the user computer 210 through the social video player operating on the browser 211. Accordingly, a user may now interact with the reconfigured media input and may provide non-media input relevant to other users viewing the reconfigured media input. The reconfigured media server 243 may comprise modules for verifying the identity of a requesting user computer 210, sending requests for information and receiving information from the social media server 232 and social media API 231 related to the user profile information stored on the social media database 233 corresponding to the identity of the requesting user at the user computer 210, storing the user information in a user database 241, generating a reconfigured media input response configured to display on the browser 211 of the user computer 210 in response to the request, including non-media inputs related to social features, linking the user computer to the media input stored at the content delivery network 250, and storing information related to user interactions from a plurality of users.

Although the above system may be described in terms of the reconfigured media server performing the functionality of embodiments of the present invention, one of ordinary skill in the art would recognize that the actions may be performed by multiple entities within the system. Accordingly, embodiments should not be limited to a particular actor performing the actions described and instead the actions could be provided by any of the entities including the social media server 232, another server at the social media website 230, another server at the reconfigured media provider 240, the browser 211 running on the user computer 210, a third party (not shown) that implements some of the functionality disclosed, or any other suitable entity in the system.

The reconfigured media server computer 241 communicates reconfigured media requests and responses (e.g., receives an order, delivers non-media inputs associated with a media input, receives user interactions, responds with non-media inputs data, etc.) with the user computer 210, social media website 230, and content delivery network 250. For example, the reconfigured media server computer 241 may serve up HTML or other content messages to the browser 211 of the user computer 210 in order to provide a social video player with different media and non-media input data 212-216. The reconfigured media server computer may comprise multiple separate server computers (e.g., a rails server computer for serving HTML pages and a node service server computer for serving high volume traffic such as chats, user interactions, engagements, etc.).

The users database 241 may comprise any information about a user that is provided during registration, account update, etc. For example, the users database 241 may comprise a user profile for each registered user that may comprise demographic, personal, preferences, payment information, and any other information that a user provides to the system to allow the system to provide services to the user. For example, favorite books or other preferences of the user may be provided by the user to the system or the reconfigured media provider may obtain the user's favorite books, movies, etc. from the social media website using social media APIs. The user profiles may be organized by user identifier and each registered user may be provided a unique user identifier.

The product database 242 may comprise product or reconfigured media input specific information. For example, the product database 242 may comprise the pointer to the content delivery network 250 where the correct media input is stored, a particular authentication token for the media input to allow a hand-shake between the content provider 250, the reconfigured media server computer 241, and the user computer 210, or any other suitable information.

The engagements database 244 comprises engagement information for the products provided by the reconfigured media provider 240. Engagements are described in further detail below but the engagement database 244 may comprise the non-media input data that may be uploaded to a user's browser 211 when they request a media input to view. The engagement data provides the user computer's browser 211 with the non-media inputs that will be triggered at particular times during playback or may be pushed to a user's browser 211 by a moderator or operator during a live event. Accordingly, the engagements database 244 may comprise the queue times, content, data links, etc. that may be necessary to deliver non-media inputs to the user's browser 211 at the correct time during delivery of the media input.

The order database 243 may comprise order information related to user requests to view media inputs. Every time a user requests a media input to view (whether the viewing is free, purchased, limited in number, etc.), an order identifier may be generated and stored in the order database 243 that allows the social media presentation system 200 to track the number of views, the length, time, date, and any other information related to the user's viewing of the product.

The feed items database 245 may comprise information related to chat. For example, the feed items database 245 may comprise a stream of chats that are associated with a product being streamed or stored in reference to a product. The chats may be filtered, organized, and otherwise managed by user, social grouping, author importance, etc. to ensure relevant chats are delivered to each user experiencing a reconfigured media input.

The interactions database 246 may comprise any data that results from or is provided by a user for user interactions, actions, expressions, or other information that a user may communicate while interacting with the reconfigured media server computer 241. For example, a user may interact with a “like” button through the browser 211 operating on the user computer 210 and the interaction may be recorded in an interaction database 246 at the central reconfigured media server computer 241. Further, user interactions could be related to trivia, a poll, or a like and any information related to the user interaction may be stored in the interactions database 241 and associated with a user identifier. The user identifier may associate the interaction with the originating user and may tie the interaction to the user profile information stored at the users database 241.

### III. DATA COLLECTION

Returning to FIG. 1, step 110 may be completed by a reconfigured media provider. The reconfigured media provider 240 may collect data from the user through any suitable manner. For example, as a user interacts with the content displayed on their browser that is delivered by the reconfigured media provider, the browser operating on the user computer may send information to the reconfigured media provider in response to such actions.

The reconfigured media provider may collect data associated with the user by collecting user profile information from other social media networks, collecting the requests for media a user makes, collecting responses to interactive content provided by the reconfigured media provider and/or third parties, monitoring user interaction with third party websites and other registered users, and any other suitable method as described herein. Accordingly, reconfigured media provider may provide users with engagements and may track the interaction the user has with the engagements, other users, and the system. For example, the reconfigured media provider may track user actions including page clicks, interaction with engagements, and requests to share data with other users, as will be described in further detail below.

A. Social Media Network Profile Data Collection

First, when a user registers with the reconfigured media provider, the user may provide social media network information that allows the reconfigured media provider to authenticate the user with a social media network profile. Accordingly, after registration, when a user interacts with the reconfigured media provider, the reconfigured media provider may access information from the social media network regarding the user's profile, their friends, and any other information that is stored on the social media network for the authenticated user.

For example, a user may provide authentication information that allows the reconfigured media provider to access a user's social media network (e.g., Facebook®) account information when the user registers with the reconfigured media provider. Accordingly, the reconfigured media provider may determine a user's friends, demographic information, geographic region, etc. This information may be stored in a user database located at the reconfigured media provider or may be accessed from the social media network when necessary. Accordingly, the reconfigured media provider may store a user's likes, friends, educational information, or any other information the user provides to their social media network. The user information may be used for a variety of users as will be described in further detail in the analysis section below.

B. Engagements

An “engagement” may include any non-media input that provides an opportunity for interaction by a user with the media presentation system. For example, engagements may include a quote, a like, a poll, trivia questions, and/or a video clip. The data for engagements (trivia questions, language in a quote, the video clip to be shared, etc.) may be pre-generated and loaded into a product file or otherwise associated with a product. For example, an engagement database 244 may include all engagement data for a product or for multiple products and may be associated to the relevant product through a product identifier. A product identifier may relate to a specific reconfigured media input or a series of related reconfigured media inputs may share a product identifier (e.g., a series of movie trailers for the same movie may share the same product identifier).

The format and sharing options for engagements may vary depending on the type of engagement or may be uniform over multiple different types. For example, Table 1 provides an exemplary engagement format:

TABLE 1
Example of an Engagement Format

| Column | Type |
|---|---|
| Engagement Identifier (“E ID”) | Integer |
| Type | Character Varying (255) |
| Published | Boolean |
| Cue Time | Integer |
| Data | Flexible Data Field |
| Product Identifier | Integer |

Engagement types may include any type of input that users may want to engage with. For example, engagement types may include a quote, a like, a poll, trivia questions, a link, and/or a video clip. The engagements allow a user to interact with the media input and/or share their interaction with other users of the social media presentation system or other social media systems.

1. Quote Engagement

A quote type of engagement may include a selected quote by a character in a movie, television show, video game, or any other media input that is presented in an easy to share format. Accordingly, a user may select the quote engagement that is displayed on their browser and be provided with an option to share the quote with their friends or other contacts in their network. Accordingly, a user may send the quote to any user they are allowed to communicate with through the system. The quote may include text, an audio clip of the character saying the quote, a picture of the scene the quote is taken from, another scene, trademark, or well-known object or item from the media input, or any other graphics, audio clips, or information that may be relevant to the media input. Accordingly, the quote type of engagement allows a user to interact and/or engage with content from the media input and easily share the content with their friends and contacts.

An example of a quote type of engagement is provided below:

TABLE 2
Example of a Quote Engagement

| | | Cue | | Product |
|---|---|---|---|---|
| E ID | Type | Time | Data | ID |
| 9052 | Quote | 60 | “name”=>“”, “text”=>“\”Oh my goodness, if only he knew\“”, | 884 |
| | | | “author”=>“Movie Title 1”, “caption”=>“”, “photo_uid”=>NULL, | |
| | | | “description”=>“”, “header_text”=>“Movie Title 1”, | |
| | | | “social_marquee_photo_uid”=>“2013/04/16/20/15/29/464/ | |
| | | | milyoni_magick_0.95192399295054991366143328.png | |

As can be seen in Table 2 above, the quote engagement is identified as engagement number 9052, is a quote type of engagement, and displays the quote “oh my goodness, if only he knew,” with a header of the media input displaying the title of the movie, “Movie Title 1.” The quote also includes a photo for the quote. The movie “Movie Title 1” is associated with product identifier 884.

Accordingly, if a user computer's browser was triggered to display the above quote to the user, the user may see the text from the above quote with a picture, movie title, and a picture of the movie. The engagement data provides a number of different user interaction options including a share option. Accordingly, the user may be able to interact with the quote engagement and the reconfigured media provider 240 may collect, store, or log interactions and expressions as a result of the user interacting with the quote engagement, as will be described in further detail below.

2. Poll Engagement

A poll type of engagement may include poll questions that are relevant to the media input. The user may interact with the poll question by selecting an answer, investigating the answers others have provided, asking for more information or different poll questions, or through any other suitable manner. In some embodiments, the poll results may only be provided if a user answers the poll question with one of the answers. As with other engagements, a user may also be provided with an option to share the poll with their friends or other contacts through email, social media posting, etc.

An example of a poll type of engagement is provided below:

TABLE 3
Example of a Poll Engagement

| E | | Cue | | Product |
|---|---|---|---|---|
| ID | Type | Time | Data | ID |
| 11 | Poll | 43 | “ask”=>“Which film from Actor | 165 |
| | | | A's illustrious career is your favorite?”, | |
| | | | “photo_uid”=>NULL, | |
| | | | “response_text”=>“Great, that's | |
| | | | ours too!”, “disable_results”=>NULL, | |
| | | | “photo_sized_uid”=>NULL, | |
| | | | “social_marquee_photo_uid”=> | |
| | | | “2013/04/16/00/29/40/584/ | |
| | | | milyoni_magick_0.928437672180.png” | |

As can be seen in Table 3 above, the poll engagement is identified as engagement number 11, is a poll type of engagement, is triggered 43 seconds into playback, and displays the poll question “Which file from Actor A's illustrious career is your favorite?,” and responds with the message, “Great, that's ours too!,” after a user enters their poll answer. Typically, this poll question would be asked where Actor 1 was either starring in the movie or had some other roll in the media input currently being watched by the user. Along with the poll engagement above, poll answers would be displayed to the user for selection.

An example of a poll answers type of engagement is provided below:

TABLE 4
Example of Poll Answers For Engagement ID 11

| Answer | | | Answered | E | | |
|---|---|---|---|---|---|---|
| ID | Answer | Correct | % | ID | Photo ID | Photo Size ID |
| 4216 | Movie | | 10 | 11 | engagement_answers/ | engagement_answers/ |
| | 1 | | | | 4216/photo.jpeg | 4216/photo_sized.jpeg |
| 4217 | Movie | | 8 | 11 | engagement_answers/ | engagement_answers/ |
| | 2 | | | | 4217/photo.jpeg | 4217/photo_sized.jpeg |
| 4218 | Movie | | 32 | 11 | engagement_answers/ | engagement_answers/ |
| | 3 | | | | 4218/photo.jpeg | 4218/photo_sized.jpeg |
| 4219 | Movie | | 20 | 11 | engagement_answers/ | engagement_answers/ |
| | 4 | | | | 4219/photo.jpeg | 4219/photo_sized.jpeg |
| 4220 | Movie | | 10 | 11 | engagement_answers/ | engagement_answers/ |
| | 5 | | | | 4220/photo.jpeg | 4220/photo_sized.jpeg |
| 4221 | Movie | | 20 | 11 | engagement_answers/ | engagement_answers/ |
| | 6 | | | | 4221/photo.jpeg | 4221/photo_sized.jpeg |

As shown in Table 4, each of the answers may have a unique answer identifier, answer text, whether the answer is correct or not (more relevant to trivia questions as poll questions may not have a correct answer), and the percentages of other users selecting that answer. Further the poll answers may have an engagement identifier reference that informs the system of which engagement the answers are associated with. Further, the answers may include links to photos to be shown with each answer.

Accordingly, if a user computer's browser was triggered to display the above poll question to the user, the user may see the poll question asking for the user's favorite movie starring Actor A and then would be provided with text from the above poll answers associated with engagement number 11, which would list the above 6 movies as possible answers to the poll question. Photos and a photo size could also be associated with each answer providing additional details about the movie (e.g., a movie cover, poster, etc.). Further, after an answer is received, the poll answers may be shown with a percentage of the user's that have selected that answer. For example, 20% of the users have selected Movie 6, so the percentages that each user has selected could be displayed for the user. Accordingly, the user may be able to interact with the poll engagement to select the answer they believe is the best answer and the reconfigured media provider 240 may collect, store, or log interactions and expressions as a result of the user interacting with the poll engagement, as will be described in further detail below.

3. Trivia Engagement

A trivia type of engagement may include a trivia question or other non-media input that asks for a response by a user and is related to the media input. The user may interact with the trivia question by selecting an answer and may be informed whether they answered correctly. In some embodiments, points or some other recognition may be provided if the user answers correctly. As with the other engagements, a sharing prompt may be provided such that the user may be able to share their results or the trivia question with their friends or others in their network.

An example of a trivia type of engagement is provided below:

TABLE 5
Example of a Trivia Engagement

| E | | Cue | | Product |
|---|---|---|---|---|
| ID | Type | Time | Data | ID |
| 7 | Trivia | 3980 | “ask”=>“Movie E is a sequel to the 2010 | 28 |
| | | | remake of Movie G. What filmmaker | |
| | | | produced the original 1978 film?”, | |
| | | | “legacy_id”=>“139”, “photo_uid”=> | |
| | | | NULL, “response_text”=>NULL, | |
| | | | “disable_results”=>NULL, | |
| | | | “photo_sized_uid”=>NULL | |

As shown in Table 5, a trivia engagement is similar to a poll engagement as described above, however, the trivia engagement may have a correct answer. In the exemplary trivia engagement of Table 5, the trivia question asks “Movie E is a sequel to the 2010 remake of Movie G. What filmmaker produced the original 1978 film?” As can be seen below, a number of answers may also be displayed for the user to interact with. The user may select their answer and then they may be informed whether they were correct as well as what the correct answer is.

An example of answers to a trivia type of engagement is provided below:

TABLE 6
Example of Trivia Answers For Engagement ID 7

| Answer | | | Answered | E | | |
|---|---|---|---|---|---|---|
| ID | Answer | Correct | % | ID | Photo ID | Photo Size ID |
| 3854 | Director | | 20 | 7 | engagement_answers/ | engagement_answers/ |
| | 1 | | | | 3854/photo.jpeg | 3854/photo_sized.jpeg |
| 3855 | Director | | 48 | 7 | engagement_answers/ | engagement_answers/ |
| | 2 | | | | 3855/photo.jpeg | 3855/photo_sized.jpeg |
| 3856 | Director | | 12 | 7 | engagement_answers/ | engagement_answers/ |
| | 3 | | | | 3856/photo.jpeg | 3856/photo_sized.jpeg |
| 3857 | Director | Yes | 20 | 7 | engagement_answers/ | engagement_answers/ |
| | 4 | | | | 3857/photo.jpeg | 3857/photo_sized.jpeg |

As shown in Table 6, each of the answers is similar to the poll answers. However, since the trivia question has a correct answer, in this case Director 4, that answer has a correct flag marked to inform the system of the correct answer.

4. Link Engagement

A link type of engagement may include any link to a webpage or other service outside the video player. For example, link engagements may be used to direct the consumer to a e-commerce retailer that may allow the consumer to purchase a sponsored product, buy tickets for an event, find out more information about the subject matter of the reconfigured media input, or find any other relevant information, services, advertisements, etc. to a user.

An example of a link type of engagement is provided below:

TABLE 7
Example of a Link Engagement

| | | Cue | | Product |
|---|---|---|---|---|
| E ID | Type | Time | Data | ID |
| 11415 | Link | 0 | “name”=>“Follow Us On:”, “caption”=>“”, | 2711 |
| | | | “location”=>“_blank”, “photo_uid”=> | |
| | | | “2013/07/11/22/52/05/10/Social_Cinema.png”, | |
| | | | “description”=>“”, “link_one_url”=>“http://social-cinema- | |
| | | | previews.socialmedianetworkA.com/”, “link_two_url”=> | |
| | | | “https://socailmedianetworkB.com/SCinemaPreviews ”, | |
| | | | “link_one_name”=>“SocialMediaNetworkA”, | |
| | | | “link_two_name”=>“SocialMediaNetworkB”, | |
| | | | “link_three_url”=>“http://socialmedainetworkC.com/ | |
| | | | socialcinemapreviews”, “link_three_name”=> | |
| | | | “SocialMediaNetworkC”, “photo_sized_uid”=> | |
| | | | “2013/07/23/19/12/02/943/Social_Cinema.png”, | |
| | | | “engagement_style”=>“medium_text | |

As shown in Table 7, a link type of engagement may comprise an engagement identifier, an engagement type, a cue time (in seconds), data including the links and display information, and a product identifier that the links are associated with. For example, the exemplary link engagement of Table 7 is directed to three different links to follow the reconfigured media provider on a number of social media networks (e.g., social media network A, B, and C). Each of the links may be displayed to the user on the browser and the user may be able to interact with the links. The links provided in the exemplary link engagement may take a user to a profile page of the reconfigured media provider on social media networks A, B, and C where the user can sign up to follow the reconfigured media provider. Further, the exemplary link engagement of Table 7 is triggered as soon as the media input begins to play for a user as the queue time is 0 seconds. Accordingly, the exemplary link engagement is an advertisement to follow or become friends with the reconfigured media provider at the beginning of a presentation of the reconfigured media input identified with product identifier 2711.

5. Clip Engagement

A video or “clip” type of engagement may include a short clip of a media input that is associated with the media input or product the user is watching, listening to, or otherwise experiencing that is configured to be easily sharable. For example, the user may be able to click on a button to share a clip of the most memorable 15 seconds of a movie, television show, or music video that they are watching or related to the media they are watching.

An example of a clip type of engagement is provided below:

TABLE 8
Example of a Clip Engagement

| | | Cue | | Product |
|---|---|---|---|---|
| E ID | Type | Time | Data | ID |
| 7689 | Clip | 45 | “name”=>“\”MovieD\“ | 1044 |
| | | | opening sequence”, “caption”=>“\ | |
| | | | ”MovieD\“ opening sequence”, | |
| | | | “description”=>“The opening sequence of | |
| | | | the film \”MovieD\“” | |

As shown in Table 8, a clip engagement may comprise an engagement identifier, a type of engagement, a cue time, and data including the clip, a link to the clip, a title or any other information related to the clip, and a product identifier that the clip engagement is associated with. The location of the clip itself may be linked to the clip engagement, may be inserted into a message if a user decides to share the clip, or a media file of the clip may be embedded into the engagement data so that the clip may be played from the displayed engagement. Accordingly, if a user clicks on the engagement, the user may watch the clip, may share the clip with other users, may post the clip to their social media network profile page, or may complete any other suitable interaction with the clip.

6. Like Engagement

A like type of engagement may include a link, API, or other information that allows a user to “like” or endorse a product, media input, character, or other related information to a reconfigured media input being displayed for the user. For example, a like engagement may link a user to a product's profile on a social media network and automatically have the user's social media profile endorse the product associated with that product. Alternatively, the user may not be linked to the website and instead a social media network API instruction may be sent to the social media network to have the user's profile endorse the product, media input, service provider, or any other relevant information that may be related to a media input.

An example of a like type of engagement is provided below:

TABLE 9
Example of a Like Engagement

| | | Cue | | Product |
|---|---|---|---|---|
| E ID | Type | Time | Data | ID |
| 6407 | Like | 0 | “link”=> | 946 |
| | | | “http://www.socialmedianetworkZ.com/ | |
| | | | movieC”, “name”=>“Movie C” | |

As shown in Table 9, a like engagement may comprise an engagement identifier, an engagement type, a cue time, engagement data, and a product identifier. As can be seen in Table 9, the present like engagement includes a link to the profile page of a movie, movie C located on social media network Z. Accordingly, if a user interacts with the like engagement, the user may be sent to the profile page of Movie C located on social media network Z, and may have their user profile “like” or otherwise endorse movie C on the social media network. Further, like the link engagement described above, the like engagement of Table 9 has a queue time of 0 seconds, so it is displayed at start-up of delivery of a reconfigured media input by the reconfigured media provider or media input by the content delivery network.

The different engagements may cycle through a user's display such that they are triggered for particular moments in the media product or they may be random, periodic, etc. Depending on the type of media input, whether the media input is a live event or an on-demand presentation, and the configuration parameters built into the reconfigured media input by the reconfigured media provider, the types of engagements, when and how they trigger, and the depth and sophistication of the engagements may vary.

For on-demand or pre-programmed reconfigured media inputs or products, the player operating through the user's browser displays engagement data to the user based on pre-configured reference times in the engagement data. For example, the browser may listen to the player wrapper (the player wrapper has a timing element that is delivered to the browser) to understand the timing of the media input and then when a page loads, the list of engagements for the delivered reconfigured media input product may be loaded into the browser. Accordingly, the player may sync the chat lists up with the timing on the player. Accordingly, all times are referenced against each other and the engagements can be pre-programmed to display at the correct time for the reconfigured media input.

However, for live events, the events are not known before they occur. Accordingly, relevant engagement data may be triggered by the media input itself or otherwise may be triggered by an operator, third party, other user, moderator, etc. to ensure that the engagement data is relevant to the live event currently playing. For example, during a live stream of a concern, the reconfigured media provider may not know what song is going to be played at what time but the reconfigured media provider may have some song specific engagements that they would like to provide when the relevant song is played. Accordingly, the engagement data may need to be pushed to the player operating on the browser from the reconfigured media provider whenever a relevant event triggers an engagement. For example, the system may determine the song by the first notes of the song and may be able to push relevant engagement data, or alternatively, a moderator may push engagement data as they observe the live event.

7. Individually Tailored Engagements

Additionally, in some embodiments, the engagements that are provided to a user during their viewing of a product may be personalized for the user based on their information stored in their user database 242 or their social media website user profile stored on the social media database 233. For example, depending on the educational background of the user, different types of trivia questions may be provided. For instance, if a user is a college graduate, they may be asked harder questions then if the user is a high school graduate. As another example, a user may be provided with questions that are relevant to their geographic location, for example, people from the northwest that are watching a movie may be asked different questions than those that are from the south. Further, different sets of engagements could be generated for women and men and any other personal information that may provide a more rewarding and engaging experience for a user. Accordingly, a customized experience could be provided to each user based on the information they provide to the reconfigured media provider, other social media networks, or through their feedback regarding previous experiences with the reconfigured media provider.

C. User Interactions

A “user interaction” may include any traceable action by a user while viewing, playing, or otherwise interacting with a reconfigured media input. For example, a user may interact with a social media player displayed on the user computer's browser by clicking on an interactive button, display, link, or other graphic displayed on the display. For instance, a user may type a chat message into a segmented chat prompt, may answer a trivia question or a poll question by selecting a displayed answer or typing an answer, may “like” or otherwise interact with a button that indicates that the user endorses a product, media input, company, individual, character, etc., or may press a share button in order to share preconfigured messages, video, quotes, content, or other information with their friends and other users in their network. User interactions generate data or communication messages that are communicated to a reconfigured media server computer and stored in interaction databases.

User interactions may include two different types of actions: (i) interactions and (ii) expressions. The different types of user interactions may generate data that may be stored in separate databases, for example, an interaction table and an expression table. Alternatively, the data may be stored in a single interactions database, user database, or general system database located at the reconfigured media server computer. Interactions and expressions are described in more detail below.

1. Interactions

Interactions include user actions that generate data that is constrained to the reconfigured media provider's platform or system. For example, interactions include a user answering a trivia question by clicking an answer to a trivia question that is presented during playback of a reconfigured media input. Another example includes a user answering a poll question that is displayed during the playback of a movie through the social media presentation system or entering a chat in the segmented chat window 116 during playback of a movie. The system may receive the answer to the trivia question, may receive the answer to the poll question, or may receive the entered chat question when the user clicks the relevant portion of the media presentation system and may store any information related to the answer, request, or chat entered by the user in an interactions table or database. Depending on the type of interaction, different information may be provided to the reconfigured media provider. Alternatively, the reconfigured media server computer may merely store that an answer was successfully provided and may not store the actual answer selected by the user.

The specific interaction data that is stored by the reconfigured media server may change depending on the type of interaction. For example, when a user answers a trivia question, the system may record a success interaction. The success interaction is recorded when the user successfully clicks on an answer to the question in an interaction table. Any type of data related to the success interaction may be also saved in the interaction table including an identifier for the type of interaction, a success flag stating that an answer was successfully received, the answer selected by the user, the time that the interaction occurred, the type of trivia question, etc. Any and all data related to the interaction may be recorded in the interaction table. The interactions may further be stored according to user ID or other identifier for the user of the system. Accordingly, interactions may be stored and associated with products, users, and orders.

a) Success Interactions

One type of interaction includes a success interaction. A success interaction is triggered where a user successfully interacts with an engagement. For example, a success interaction may be generated when a user answers a trivia question and may be received regardless of whether they answer the trivia questions correctly or not.

Table 10 shown below provides exemplary success interactions that are organized by action, object, and destination. For example, success interactions may be received when a user successfully interacts with a chat message (e.g., FeedItem), poll engagement, trivia engagement, or when the user verifies their social media network information so that the system may access the users' social media network profile (e.g., “OAuth”).

b) Click Interactions

Another type of interaction includes a click interaction. A click interaction includes where the user interacts with the system to start a movie, pause, stop, etc., but where the click does not trigger or related to a specific engagement. For example, a user may indicate they are interested in learning more about a movie and click on a link that says, “learn more” or may open a window that provides a list of social connections related to the movie—i.e., other friends or people in the network that are connected to the movie or other media input. There are many different interactions that a user can complete that are not specifically interacting with an engagement item but that still shows a user's engagement with a media input. These interactions are most likely characterized as click interactions.

Table 10 shown below provides exemplary click interactions that are organized by action, object, and destination. Click interactions include an action of a click. However, the object that is being clicked by a user is different for each click interaction. For example, an activity feed may include a list of a user's previous messages, transactions, and other activities with the reconfigured media provider. Each of the exemplary objects include a different area on the video player or different web pages provided by the reconfigured media server computer that a user may interact with (e.g., a “BackToGallery” object include a link on a video player that allows a user to view a lobby of available reconfigured media inputs that a user may view).

c) Visit Interactions

Another type of interaction that is tracked and stored by the system includes a visit interaction. Visit interactions include tracking of a user as they contact different portions of the website. For example, every time a user's web browser requests information from the reconfigured media server computer related to a particular HTML page, the location where the user is coming from may be stored in an interaction table along with the user identifier. Accordingly, the system can track how users are coming to their website and where the user is moving throughout the website. Any other information may be stored in the interaction table including a product identifier, order identifier where the page is a media input request, time and date, etc. Additionally, in some embodiments, a tracking identifier may be stored that is tied to shared data provided by other users when they shared links to a media input. The tracking identifier allows the system to see what users are driving other users to visit the reconfigured media provider's website. More details will be provided regarding the tracking identifier in the expressions section below.

d) Attempt Interactions

Another type of interaction that is tracked and stored by the system include what is called an attempt interaction. An attempt interaction includes a request by a user to connect their user profile registered with the reconfigured media provider to a social media network outside the reconfigured media provider and includes an authentication of the user with the social media network. For example, Twitter®, Facebook®, Myspace®, or any other social media provider account may be linked to the reconfigured media provider website. When a user attempts to link their social media provider account to their reconfigured media provider account to allow sharing of information between the two systems, an attempt interaction is logged. The attempt interaction allows the reconfigured media provider to share actions across multiple social media networks. Accordingly, the attempt interaction authenticates the user to the external social media network and allows seamless sharing between networks without interrupting a user's media experience.

2. Expressions

Expressions are user interactions that result in information being shared with other users inside and/or outside the reconfigured media provider system. For example, a user may answer a trivia question and may receive a prompt informing them that they answered the question correctly and allowing them to share their results with their friends or other connections on a social media network. If the user selects the option to share the results, a share type of expression may be generated and stored at the reconfigured media provider indicating that the user shared their trivia results with their friends. Additionally, some other interactions may generate shared content automatically as an information link that may be posted on a use's global or shared activity “wall” (e.g., OpenGraph® by Facebook®).

a) Share Expressions

“Share” expressions are user interactions that result from a user agreeing to or asking to share the results of an interaction, engagement, chat, or other activity on the social media presentation system. For example, share expressions may result from a user sending a video clip to their wall, their friends, or any other users within their network. The user may select a clip, one or more recipients or sharing channels (e.g., Twitter®, Facebook®, Google+®, etc.), and may request that the clip be shared with the users, channel, or their profile within a social media network. In response, a share expression may be stored by the reconfigured media provider and the video clip may be distributed as the user requested. Similar functionality may be provided for chat entries (“feed items”), poll questions and answers, quotes related to media inputs, a user starting to watch a movie or otherwise starting to interact with a media input or product, as well as trivia questions and answers.

b) Social Tracking Expressions

“Social tracking” expressions are shares that automatically update to a social media network's community tracking area based on user actions outside of expressly requesting or agreeing to share the information. Social tracking expressions may be generated and stored based on a user's actions including starting to watch a media input, when the answers a poll question or trivia question, and when the user starts chatting during a media input. When the user starts interacting with the social media presentation system, for example, by pressing play on the movie player, a social tracking message may be generated and sent to Facebook® that says “User A started watching Movie Title 1.” Additionally, when this passive expression is generated, the reconfigured media provider may store such actions as a social tracking expression in the expression database. Social tracking expressions are considered passive expressions because the user is not specifically asking for the data to be shared, whereas other expressions are active expressions because the user is requesting the share.

c) Like Expressions

“Like” expressions are shares that endorse a product, movie, media input, provider, manufacturer, corporation, or any other product or entity by a user. The user is expressing to other users that the user is endorsing or recommending the product that is being liked. Accordingly, the like shares are outbound messages to friends and other contact on the social media networks that a user endorses the subject of the like. Accordingly, the reconfigured media provider may store a like expression when a user likes a media input, partner company, or any other aspect presented through the social media presentation system.

The following table provides some exemplary user interactions (both interactions and expressions) that may be implemented according to embodiments of the present invention.

TABLE 10
List of Exemplary Interactions

| Action | Object | Destination |
|---|---|---|
| Attempt | OAuth | Twitter ® |
| Click | ActivityFeed | Facebook ® |
| Click | BackToGallery | |
| Click | Like | Facebook ® |
| Click | PageChiclet | Facebook ® |
| Click | PageChiclet | Google+ ® |
| Click | PageChiclet | Facebook ® |
| Click | SocialConnections | Facebook ® |
| Click | SocialConnections | Twitter ® |
| Click | SocialDiscovery | Facebook ® |
| Social tracking | Answer_a_poll | Facebook ® |
| Social tracking | Answer_trivia | Facebook ® |
| Social tracking | Chat | Facebook ® |
| Social tracking | Watch | Facebook ® |
| Share | Clip | Facebook ® |
| Share | Clip | Twitter ® |
| Share | FeedItem | Facebook ® |
| Share | FeedItem | Twitter ® |
| Share | PageChiclet | Facebook ® |
| Share | Poll | Facebook ® |
| Share | Poll | Twitter ® |
| Share | Quote | Facebook ® |
| Share | Quote | Twitter ® |
| Share | StartWatching | Facebook ® |
| Share | Trivia | Facebook ® |
| Share | Trivia | Twitter ® |
| Success | FeedItem | |
| Success | Oauth | Twitter ® |
| Success | Poll | |
| Success | Trivia | |
| Visit | Gallery | |
| Visit | PaidLobby | |
| Visit | Screen | |
| Visit | UnpaidLobby | |

As can be seen in Table 10 above, in some embodiments, the different types of user interactions may be separated according to action, object, and destination. An action is a user action that is performed to generate the interaction (e.g., clicking an object displayed on a user's browser, requesting to share an object, visiting an area of a website, answering a trivia question, etc.), an object is the non-media input or name of the interactive area on the reconfigured media provider's website that the action was taken on by the user (e.g., a poll question, trivia question, social connections window, etc.), and a destination is the end destination for the user's interaction (e.g., Facebook®, Twitter®, etc.) if there is one (i.e., only for expressions). A pagechiclet may include an interaction button for sharing information with a number of different social media networks with a single message (e.g., designating a number of different social media networks by turning a button (e.g., “pagechiclet”) on or off for that social media network.

d) Expression Tracking Identifiers

Some embodiments of the present invention may provide a tracking identifier that is uniquely associated with each expression that is generated by the social media presentation system. The tracking identifier may be unique for each and every expression because the tracking identifier is unique for each user and engagement that is associated with the expression. For example, the tracking identifier may include a 64 bit code that includes information tied to the engagement (e.g., trivia question), the type of expression (e.g., share), the time it was originated, the channel used to send the expression (e.g., Facebook®), etc. Accordingly, no two shares may have the same tracking identifier.

The tracking identifier may be unique so that as an expression is passed through the world wide web, the system can attribute the new viewer (or new viewer) to an originating user identifier. For example, the tracking identifier may be associated with a user identifier that first generated the expression. Accordingly, when a new viewer clicks on the expression or otherwise interacts with the expression, the tracking identifier is included in the information that is returned to the social media presentation system when a new viewer follows the link in the expression to the social media presentation system. Accordingly, the social media presentation system is capable of tracking the source of new viewers if the visit is generated by an expression from an existing user. Accordingly, as an expression is shared through multiple web pages (e.g., shared trivia results that are posted to a person's Facebook® wall may be forwarded by another user browsing that user's wall to another user outside of Facebook®), the system can track who is driving people back to the website and attribute the visit or new account creation to the originating user of the expression. The number of new viewers that are attributed to a user identifier may be tracked and maintained in a user database at the reconfigured media provider.

e) Social Connectedness Measurement

Embodiments of the present invention may also collect a social connection or social circle measurement between a new viewer and the originating user for an expression. For example, when a new viewer uses a link from an expression originating from a user, as described above, the reconfigured media provider may determine a social connectedness level between the new viewer and the originating user of the expression.

A social connectedness level may include a measurement of how close of friends the new viewer and the originating user are. The social connectedness of the new viewer and the existing user may be determined through a number of methods. For example, the social media network of the new viewer may be analyzed for the originating user to determine if they are direct friends. If they are not friends, the reconfigured media provider may investigate the new viewer's profile and the originating user's profile for mutual friends. If no mutual friends exist, the reconfigured media provider may analyze the new viewer and the originating user's common interests, geographic location, joined groups, networks, or other aspects that may provide insight into how similar of interests, social circles, and how close the social connectedness of the new viewer and the originating user may be. Finally, if no clear connection can be made, the reconfigured media provider may determine that the new viewer and the originating user are completely unconnected. Accordingly, a social mapping may be determined between the new viewer and the originating user.

The social connectedness level may be stored in any suitable manner. For example, the social connectedness may be implemented through a sliding scale from 1-10 based on a variety of similarity factors between the new viewer and the originating user's social media profiles, the directness of their relationship, etc. Alternatively, a limited number of characterizations could be provided (e.g., direct, friends of friends, connected through interests, unconnected). The reconfigured media provider may store the social connectedness of the new viewer and the originating user in a user database for both the new viewer and the originating user and may tie the connectedness to the product identifier as well.

Any other suitable methods for determining the closeness of interests and connections between users may also be used to determine the extent to which expressions are moving through the internet and driving new viewers to the system or product.

f) Feed Item/Chat Expressions

Feed items are a type of share expression that includes chat messages to be displayed during a media input presentation. The feed items include a serial set of chat messages (called a feed item) that include the text that a user has entered in chat. Feed items include a unique identifier, an author type (e.g., user or persona), author identifier, text of the chat message, data, and a product identifier (e.g., media input identifier) that will associate the feed item with the correct media input.

Table 11 provides an exemplary format for a chat item (“Feed Item”) that can be shared.

TABLE 11
Exemplary Format for Feed Items

| Column | Type |
|---|---|
| Feed Item ID | Integer |
| Created Date | Time stamp |
| Updated Date | Time stamp |
| Author Type | Character Varying (255) |
| Author ID | Integer |
| Text | Text |
| Data | Flexible Data Field |
| Product ID | Integer |

When a user enters a message into the chat field, the reconfigured media provider stores a Feed Item entry in a Feed Item database and the Feed Items are associated or tied to users and products through a user identifier and a product identifier, respectively. The Feed Items can be provided precedence for display to particular users and otherwise filtered based on a user's network, interests, etc.

Accordingly, there are numerous ways that the reconfigured media provider may track and collect data based on a user's interaction with the social media presentation system and media input player that is operating on the user computer's browser. Further, the reconfigured media provider is not limited to these collection methods and may implement numerous additional collections of user data based on user interactions with engagements, user interactions, etc. in any suitable manner in the future.

g) Example Format for User Interactions

Example user interactions stored in an interaction database are shown in the table below:

TABLE 12
Example of User Interactions for User Identifier 3485

| Interaction | Studio | Product | User | | | | |
|---|---|---|---|---|---|---|---|
| Id | ID | ID | ID | Data | Object | Action | Destination |
| 1839525 | 178 | 2204 | 3485 | “url”=>“/studios/17 | Watch | Social | Facebook ® |
| | | | | 8/products/2204- | | Tracking | |
| | | | | movie- | | | |
| | | | | title/contents/1651/ | | | |
| | | | | watch”, | | | |
| | | | | “session_id”=>“84 | | | |
| | | | | 962172516a3b9be9 | | | |
| | | | | 936c69965f5e77”, | | | |
| | | | | “tracking_id”=>“ris | | | |
| | | | | escptwittersunday” | | | |
| 1839526 | 178 | 2204 | 3485 | “url”=>“/studios/17 | Answer | Social | Facebook ® |
| | | | | 8/products/2204- | Poll | Tracking | |
| | | | | movie- | | | |
| | | | | title/contents/1651/ | | | |
| | | | | watch”, | | | |
| | | | | “session_id”=>“84 | | | |
| | | | | 962172516a3b9be9 | | | |
| | | | | 936c69965f5e77”, | | | |
| | | | | “tracking_id”=>“ris | | | |
| | | | | escptwittersunday” | | | |
| 1839527 | 178 | 2204 | 3485 | “url”=>“/studios/17 | Poll | Success | |
| | | | | 8/products/2204- | | | |
| | | | | movie- | | | |
| | | | | title/contents/1651/ | | | |
| | | | | watch”, | | | |
| | | | | “session_id”=>“84 | | | |
| | | | | 962172516a3b9be9 | | | |
| | | | | 936c69965f5e77”, | | | |
| | | | | “tracking_id”=>“ris | | | |
| | | | | escptwittersunday”, | | | |
| | | | | “engagement_id”= | | | |
| | | | | >“11226”, | | | |
| | | | | “engagement_answ | | | |
| | | | | er_from_user_id”= | | | |
| | | | | >“67895” | | | |
| 1839528 | 178 | 2204 | 3485 | “url”=>“/studios/17 | Screen | Visit | |
| | | | | 8/products/2204- | | | |
| | | | | movie- | | | |
| | | | | title/contents/1651” | | | |
| | | | | ,“session id”=>“84 | | | |
| | | | | 962172516a3b9be9 | | | |
| | | | | 936c69965f5e77”, | | | |
| | | | | “tracking_id”=>“ris | | | |
| | | | | escptwittersunday” | | | |
| 1839529 | 178 | 2204 | 3485 | “url”=>“/studios/17 | Paid | Visit | |
| | | | | 8/products/2204- | lobby | | |
| | | | | movie- | | | |
| | | | | title/contents/1651” | | | |
| | | | | ,“session_id”=>“84 | | | |
| | | | | 962172516a3b9be9 | | | |
| | | | | 936c69965f5e77”, | | | |
| | | | | “tracking_id”=>“ris | | | |
| | | | | escptwittersunday” | | | |

As shown in Table 12, the user interactions may include a unique interaction identifier, a studio identifier, a product identifier, a user identifier, a data field, an object, an action, and a destination. In the example provided in Table 12, the user interactions are directed to a single user (with user identifier 3485). The user interactions include both interactions (e.g., a success and two visit interactions) as well as expressions (e.g., social tracking interaction). Further, the data fields are different for each interaction and include unique tracking identifiers, engagement identifiers (where relevant), and links to relevant content or other information (e.g., for a visit interaction, the address where the user came from is recorded).

D. Method of Data Collection

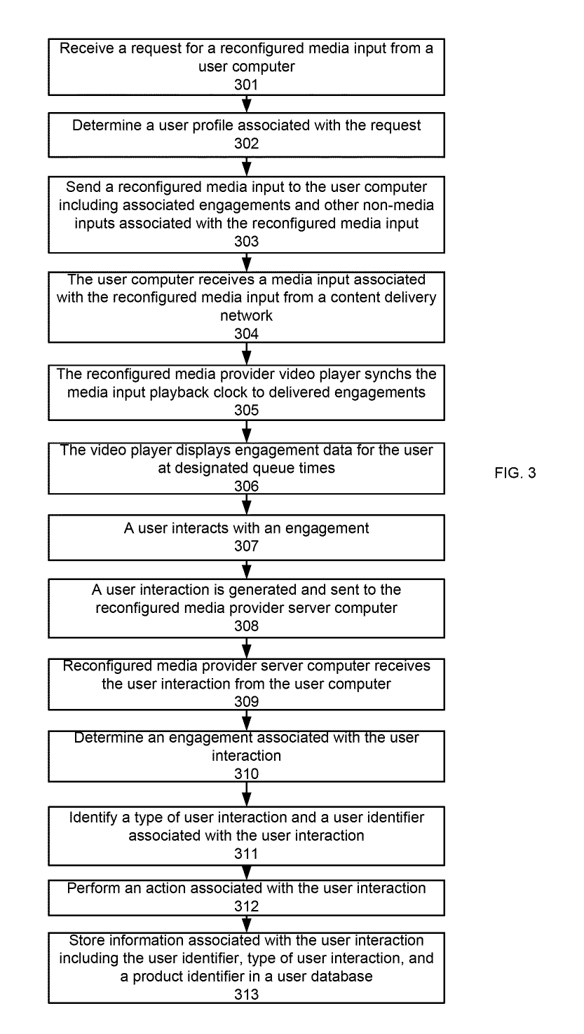

Embodiments of the present invention may collect data generated and provided as a result of user interactions with the above-described engagements. FIG. 3 provides an exemplary method of collecting data from users interacting with the social media presentation system.

At step 301, a user may use a browser (or mobile application) operating on their user computer to contact the reconfigured media provider server and request a reconfigured media input being offered through the social media presentation system. Accordingly, the reconfigured media server computer may receive a request for a reconfigured media input from the user computer.

At step 302, the reconfigured media server computer may determine a user profile associated with the request for the reconfigured media provider. For example, the reconfigured media server computer may parse a user identifier associated with the request and may search a user database for the user profile that is associated with the user identifier. Any suitable method for determining the user profile associated with the request may be used.

At step 303, the reconfigured media provider may send a reconfigured media input to the user computer including associated engagement data and other non-media inputs associated with the requested reconfigured media input. The engagement data may be stored in a local memory on the user computer and the user computer may contact or be contacted by a content delivery network that is storing a media input associated with the reconfigured media input.

At step 304, the user computer receives the media input associated with the reconfigured media input from a content delivery network. The content delivery network may receive an authorization or authentication data from the reconfigured media provider or directly from the user computer in order to ensure the user has access rights to receive the media input (e.g., that the user has purchased or otherwise is authorized to view the media input).

At step 305, the reconfigured media provider video player loads on the browser or the user's computer and the video player begins playback of the media input. The reconfigured media provider's video player may synch the media input playback clock with the video players clock and the video player may begin providing non-media inputs that are relevant to the media input when the queue time of the non-media inputs triggers the data to be displayed. For example, the video player may track the time of the playback and may choreograph all of the display content based on the playback time.

At step 306, the video player displays engagement data for the user at designated queue times. The engagement data that was provided by the reconfigured media provider with the reconfigured media input may have designated queue times that the data is to be displayed to a user. For example, at 3245 seconds into the playback of a movie, a character may state a famous quote and a quote engagement may be triggered that displays a quote engagement that the user may be able to interact with. Any of the exemplary engagement types described above and many other types of engagements may be triggered and displayed in this manner, as one of ordinary skill would recognize. Further, multiple engagements may be displayed at the same time in different areas of the video player. An exemplary video player and its capabilities are described in U.S. patent application Ser. No. 13/961,783, filed Aug. 8, 2013, which is hereby incorporated by reference, in its entirety, for all purposes.

At step 307, the user interacts with a displayed engagement through the video player operating on the user computer's browser. For example, the user may enter a chat message, answer a poll or trivia question, select a share button, click a link, or interact in any other manner as described above and as one of ordinary skill in the art would recognize.

At step 308, the browser generates a user interaction and sends a user interaction message to the reconfigured media server computer. The user interaction message may comprise a user identifier, an engagement identifier, a product identifier, the type of engagement being interacted with, the content of the interaction (where applicable), the date and time, and any other information that may be relevant to the reconfigured media provider.

At step 309, the reconfigured media provider receives the user interaction message from the user computer. The reconfigured media provider may receive the user interaction in response to any input by the user with an engagement or the user interaction may be generated periodically and include any number of user interactions that have been completed since the previous user interaction message.

At step 310, the reconfigured media provider server computer may determine an engagement associated with the user interaction. The reconfigured media provider server computer may identify an engagement through any suitable method. For example, the reconfigured media provider server computer may parse an engagement identifier from the user interaction, may search an engagement database for the relevant engagement, and may obtain additional information about the engagement such as the type of engagement, associated product, and any other information based on the engagement database. Alternatively, the user interaction message may comprise all of the relevant information and the reconfigured media provider may merely obtain the relevant information (e.g., type of engagement, engagement identifier, product identifier, etc) from the user interaction.

At step 311, the reconfigured media provider server computer identifies the type of user interaction and a user identifier associated with the user interaction. The types of user interactions may include the exemplary interactions and expressions that are described above as well as other interactions and expressions as one of ordinary skill would recognize. Depending on the type of interaction, the reconfigured media provider may provide points, complete additional tasks, and store different information. For example, if the user interaction is determined to be a passive expression, a social tracking message may be generated and sent to a second computer system. However, if the interaction is merely a click on a new page to move to the video lobby, then the response may be webpage information for the destination address. Accordingly, the amount of data and the complexity of the actions in response to the received user interaction may be dependent on the type of interaction.

Further, in some embodiments, the type of user interaction may include determining if the user interaction includes a request to share information with a server computer operated by the social media network or not. If so, the type of user interaction may include an expression. If not, the user interaction may include an interaction because information is not being shared outside of the social media presentation system.

At step 312, the reconfigured media provider server computer performs any actions associated with the requested user interaction. The actions may include generating messages and forwarding information or instructions to other systems, providing a response message back to the user computer, sending emails, SMS text messages, or other information to a particular user or unregistered person, completing a purchase, redirecting the browser of the user computer to a different webpage, or any other action that may be requested by the user's actions. For example, if the user selects an answer to a trivia question, the reconfigured media provider may generate and send a message that inform the user if they selected the correct answer. Additionally, if the user selects a share link for the trivia question, the reconfigured media provider server computer may generate a share message configured for the selected social media network, email address, or other communication channel and may send the share information to the designated account, system, or other entity.

At step 313, the reconfigured media provider may store the information associated with the user interaction including the user identifier, type of user interaction, and a product identifier in a user database. Accordingly, users' interactions, activities, level of engagement, and any other data that is received by the reconfigured media provider may be collected by the reconfigured media provider.

E. Example of Data Collection Method Using Expressions

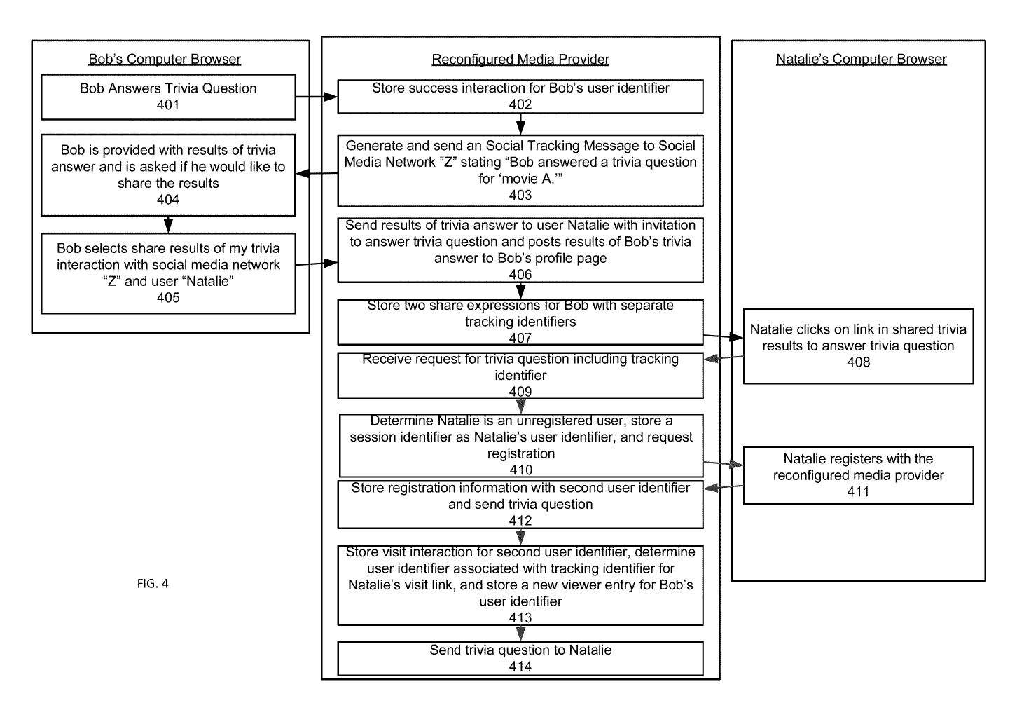

FIG. 4 shows an exemplary flowchart of a method of data collection from user expressions in the reconfigured media presentation system. The exemplary method of FIG. 4 shows a first user computer (Bob's computer browser) and a second user computer (Natalie's computer browser) communicating with a reconfigured media provider during playback of a reconfigured media input. Prior to the first step of the method shown in FIG. 4, Bob's user computer requested a reconfigured media input associated with “movie” from the reconfigured media provider and Bob is watching “movie A” on his browser.

At step 401, Bob's computer browser may display a trivia engagement at the appropriate queue time during playback of movie A. Bob may select an answer to the trivia question presented by the trivia engagement. When Bob selects an answer to the trivia question, a trivia response message is sent to the reconfigured media provider server computer. The trivia response message may include Bob's user identifier, the answer selected by Bob, a product identifier for Movie A, and any other information that may be relevant to the reconfigured media server computer.

At step 402, the reconfigured media player stores a success interaction associated with Bob's user identifier. As described above, a success interaction is generated when a user successfully interacts with an engagement. Accordingly, when the reconfigured media provider receives an answer to the trivia engagement, a success interaction is generated and stored with Bob's user identifier in the interactions database. Accordingly, the reconfigured media provider now knows that Bob has answered a trivia question for the reconfigured media input, the type of trivia question, and any other relevant information may be stored in the interactions database for later analysis.

At step 403, the reconfigured media provider determines a social media network associated with Bob's user identifier or user profile and generates and sends a social tracking message to social media network “Z” stating, for example, “Bob answered a trivia question for Movie A.” The reconfigured media provider may also generate a trivia engagement response message that is sent to Bob.

At step 404, Bob's user computer receives results of the trivia answer (e.g., may include whether he was correct, the percentage of other users who answered correctly or answered with each selection, etc.). Bob's computer browser may display the results of the trivia answer and may ask Bob if he would like to share the results of his trivia answer.

At step 405, Bob selects an option to share the results of the trivia interaction with social media network “Z.” Additionally, Bob may select that he would like to share the results specifically with his friend “Natalie.”

At step 406, the reconfigured media provider receives Bob's share interactions. The reconfigured media provider may send the results of the trivia answer to user Natalie along with an invitation to answer the trivia question and posts results of Bob's answer to Bob's profile page on social media network Z.

At step 407, the reconfigured media provider stores two share expressions associated with Bob's user identifier. Each share expression may also have separate unique tracking identifiers associated with each of the expressions (social media network share and direct email share). If Natalie or another user interact with the links included in the share expressions and if Natalie's or the new viewer's browsers are transferred to the reconfigured media provider, the reconfigured media provider may be capable of determining that Bob was the user that generated the new viewer.

At step 408, Natalie's Computer Browser receives the results of Bob's expression directed towards her. Natalie may receive the expression through her email, SMS text, social media network (e.g., Facebook™ page, a Tweet™ with her user identifier tagged, etc.), or any other suitable medium. Once Natalie logs onto the relevant service or opens the message sent by the reconfigured media provider, Natalie may receive a link to the reconfigured media provider server computer website that provides the results of Bob's trivia answer and also allows Natalie to answer the trivia question. In some embodiments, the message sent to Natalie may state, for example, “Bob just correctly answered a trivia question about Movie A and he thinks you would like to join in the fun! Click the link below to answer the trivia question too!”

At step 409, if Natalie clicks on the link, Natalie's browser may be directed to the reconfigured media provider server, and the reconfigured media provider may receive a request for a trivia question including a tracking identifier that was created when Bob asked to share the trivia question and answer. Accordingly, the reconfigured media provider may know that Bob was responsible for Natalie contacting the reconfigured media provider and asking to answer the trivia question.

At step 410, the reconfigured media provider may determine that Natalie is a new viewer and is unregistered. The reconfigured media provider may determine Natalie is unregistered through any suitable method including asking for a username and password, storing a cookie or other tracking information on all registered users' computers, or through any other suitable manner. Accordingly, the reconfigured media provider may request that Natalie register in order to gain access to the trivia questions and answers.

At step 411, Natalie's user computer may receive the registration request and may provide user information in order to register for a new account. The registration process may be performed through a third party service (e.g., one or more social media networks) or directly with the reconfigured media provider. Before Natalie registers, her actions, interactions, expressions, etc. may be stored according to a session identifier. Accordingly, the system may not lose her actions and the data she generates if she decides not to register or is interrupted.

At step 412, the reconfigured media provider may receive and store Natalie's registration information as being associated with a second user identifier (Natalie's designated user identifier). The reconfigured media provider may then send the trivia question engagement to Natalie's user computer. Further, during registration the reconfigured media provider may also gain information about Natalie's profiles on social media networks and may obtain a large amount of information about Natalie's interests, friends, contact information, etc., from the social media network. Additionally, the interests, friends, etc., may also be determined through the registration information provided by Natalie.

At step 413, the reconfigured media provider may store a visit interaction associated with the second user identifier (i.e., Natalie's user identifier) and may determine a user identifier associated with the unique tracking identifier that was embedded in Natalie's visit link. Once the reconfigured media provider determines Bob's user identifier is associated with the unique tracking identifier, the reconfigured media provider may store a new viewer entry for Bob's user identifier. Accordingly, Bob has been provided credit for generating a new viewer and driving users to the reconfigured media provider and specifically to the product (e.g., reconfigured media input) that was associated with the trivia engagement.

Further, in some embodiments, the reconfigured media provider may determine a social separation value between the user associated with the tracking identifier (e.g., Bob) and the new viewer (e.g., Natalie). Accordingly, the social separation value may be determined through a number of different methods including whether the two people are direct or indirect friends on a social media network, looking at the interests of both user profiles to determine whether they share interests, or through any other suitable method as disclosed herein. Accordingly, the social separation value may be associated with the new viewer entry that is associated with Bob's user identifier. Accordingly, the social separation value may be used to determine if a reconfigured media input is moving through multiple social groups and may be used to better estimate the engagement levels and popularity of a reconfigured media input. These values may be used later to determine the possible success of an event or media input.

At step 414, the reconfigured media input sends the trivia engagement to Natalie's browser. Accordingly, the reconfigured media input has completed Bob's share expression and driven a new viewer through the expression of Bob. Further, the reconfigured media input may be delivered along with a media input from the content delivery network, using the methods disclosed herein.

Accordingly, at this point in the example process of FIG. 4, engagements have been provided to a plurality of users and user interactions including expressions related to the engagements have been tracked, delivered, and otherwise provided to new viewers, current viewers, and any other related systems. Accordingly, over a large number of interactions, expressions, and delivered engagements, a reconfigured media provider may be capable of collecting large amounts of information about users, media inputs, and the interests, preferences, and desires of customers. Accordingly, vast amounts of data may be collected that may be analyzed in order to gain insight about consumers' interests, engagement level, and ultimately used to predict the success of a reconfigured media input.

### IV. DATA ANALYSIS

Once the reconfigured media provider collects information based on the user interactions of a user, the reconfigured media provider may analyze the data to gain insight into a user's engagement level and social clout, a product's popularity or interest level, and may be able to predict the success of a media event based on the level of user interaction or engagement with a product.

Accordingly, the reconfigured media provider may store a large amount of user information regarding the level of engagement or activity surrounding the media input products provided through the social media presentation system. Accordingly, the reconfigured media provider may use a number of data algorithms to determine different user behavior, rankings, and insights into the products themselves. By aggregating and analyzing this information individually, the reconfigured media provider may provide a number of predictions, insights, and analysis regarding the products. The reconfigured media provider may then take a number of actions to improve the media inputs to increase viewership, purchases, or otherwise success of media input events.

Therefore, the reconfigured media provider may use a social marquee effectiveness ratio, a social productivity measurement (SPM), and a universal product engagement measurement to predict the success of a media event. Each of these measurements will be described in further detail below along with algorithms for predicting success of events.

A. Social Marquee Effectiveness Ratio

The first social engagement measurement may be referred to as a social marquee effectiveness ratio. A social marquee effectiveness ratio is directed to measuring the total number of expressions it takes to create a new viewer. This measurement may be obtained on a user level (i.e., user social marquee effectiveness ratio), an aggregate level (i.e. aggregated social marquee effectiveness ratio for all users) across the entire system, or at a product level (i.e., product social marquee effectiveness ratio).

As explained previously, when content is shared to users and websites outside of the social media presentation system provided by the reconfigured media provider, an expression is generated with a unique tracking identifier. The unique tracking identifier may be returned with any new viewer that uses the shared expression to link back to the social media presentation system. Accordingly, when a new viewer contacts the reconfigured media provider, the social media server computer receives the tracking identifier, determines the user identifier associated with the tracking identifier, and increments a new viewer counter for that particular user identifier. Accordingly, the originating user for the expression that led to a new viewer may obtain credit for generating the new viewer through their expression. Additionally, the expression identifier, engagement identifier, product identifier, etc. may also be stored as being associated a new viewer being generated. Any other suitable method for attributing the new viewer to a user identifier or product identifier is possible.

Further, when the reconfigured server computer receives the new viewer through the expression link, the new viewer's visit interaction is generated and the URL of the website where the user was when they clicked on the expression is also stored along with the tracking identifier. Accordingly, by storing new viewer generation data, the system may determine how and from where new viewers are driven to the social media presentation system. Using these determine new viewer metrics, a number of different social marquee effectiveness ratios may be calculated.

1. User Social Marquee Effectiveness Ratio

A user social marquee effectiveness ratio captures the social “clout” or ability of users within the social media presentation system to drive new viewers to view a product. For example, users that have a lot of social clout may drive a lot of new viewers and users to the social media presentation system. Accordingly, star users or users with a large amount of social clout may be determined by examining the number of expressions a user generates divided by the number of new viewers the user is attributed.

$${SMER}_{U} = \frac{No . of UserExpressions}{No . of Attributed New Viewers} \qquad ( 1 )$$

The user social marquee effectiveness ratio (SMERu) may provide insight into those users that drive a lot of new viewers per the number of user expressions the user is responsible for. Further, these measurements may be further refined by removing passive expressions and only counting the number of active expressions of the user.

2. Total User Social Impact

Additionally, a total user social impact may be calculated once a User Social Marquee Effectiveness Ratio is calculated. The Total User Social Impact is equal to the user social marquee effectiveness ratio multiplied by the size of a user's social network. A user's social network may be determined through any suitable method. For example, a size of a social network may be determined by adding the number of friends, followers, subscribed users, and any other users that may be receive an expression from a user through one or more social media networks that the user has provided the reconfigured media provider access to. An exemplary equation for the total user social impact is below:

$$User Social Impact = \frac{No . of UserExpressions}{No . of Attributed New Viewers} * Size of Social Network \qquad ( 2 )$$

A user's total social impact may be important because it allows the system to determine the total impact of user across multiple social media networks. For example, a user that has a low User SMER but only has a small number of followers may not be as valuable as a user with a low user SMER and a large number of followers. Accordingly, the total user social impact is a way to determine the total social clout a user has, outside of a user's normalized value for the number of attributed new viewers.

3. Aggregate Social Marquee Effectiveness Ratio

Further, the user social marquee effectiveness ratio may tracked on an aggregate level in order to determine the overall engagement level of the social media presentation system to drive new viewers. Accordingly, an aggregate social marquee effectiveness ratio may be calculated which determines the total number of expressions it takes to drive new viewers across all products, users, etc.

$${SMER}_{Agg .} = \frac{Total No . of UserExpressions}{Total No . of New Users} \qquad ( 3 )$$

The aggregate social marquee effectiveness ratio (SMER_{Agg}.) may be used to determine the overall effectiveness of the system to drive new viewers and product engagement.

4. Product Social Marquee Effectiveness Ratio

A product social marquee effectiveness ratio may also be used to measure the total effectiveness of the product to obtain new viewers for the system. For example, the total number of expressions originating from a particular product may be measured using the data collection methods discussed above. Specifically, the product identifier that may be included in expressions may tie new viewer tracking identifiers to product identifiers. Accordingly, a product may be attributed with new viewers when a user is driven to the social media presentation system by an expression related to a particular product.

$${SMER}_{P} = \frac{Total No . of Expressions for Product}{Total No . of New Viewers} \qquad ( 4 )$$

Accordingly, the SMER_{P} measures the total number of expressions (i.e., interactions that are shared outside the social media presentation system) related to a product that it takes for the system to generate a new viewer. Accordingly, the system can determine the effectiveness of the product to drive new viewers to join the social media presentation system.

5. Engagement Social Marquee Effectiveness Ratio

An engagement social marquee effectiveness ratio may also be used to measure the total effectiveness of a particular engagement to generate new viewers for a product. For example, the total number of viewers originating from a particular engagement may be measured using the data collection methods discussed above. Specifically, the engagement identifier that may be included in expressions may tie new viewer tracking identifiers to product identifiers. Accordingly, a particular engagement tied to a product may be attributed with new viewers when a user is driven to the social media presentation system by an expression related to a particular product.

$${SMER}_{E} = \frac{Total No . of Expressions for an Engagement Indentifier}{Total No . of New Viewers} \qquad ( 5 )$$

6. Social Effectiveness Dampening Factor

The social marquee effectiveness ratio can also take into account that the effectiveness of user's expressions drop once they get outside of their personal network. The effect of this drop in social effectiveness is referred to as a social effectiveness dampening factor. Users are more influential on close friends that share their interests and provide a level of authenticity to a recommended product. Accordingly, recommendations are less effective on strangers or those who do not know the tastes, interests, and experiences of the user. As such, a social dampening factor may be used to discount the effect of an expression as it moves from close friends, to acquaintances, to random or unknown users.

For example, a user social marquee effectiveness ratio may be high for immediate contacts or friends within a social media network and for every 5 expressions, a user may drive 2 new friends to join the system. However, as the expression progresses through the world wide web and is viewed by persons who are not directly within the user's network, the effectiveness of the expression is going to dampen. This may cause a ripple factor of effectiveness through the system. So over time, we'll have a dampening factor that dampens the effectiveness of a user's expressions on driving new viewers.

As another example, while a user is watching a concert for Band 1, the user may be generating expressions regarding the concert. For example, the user may be answering trivia, sending chats, sharing videos and lyrics about the concert, etc. The user's direct friends are most likely interested in these expressions because they likely have the same or similar interests in music, style, art, etc. that the user does. However, when the expression goes beyond the user's immediate friends out to say, friends' parents, they may not know who the band is or enjoy the same type of music as the user. Accordingly, expressions are less likely to drive users at removed social levels beyond immediate friends or contacts. However, when a user is still driving new viewers at social groupings outside of their immediate contacts, a viral event may be tipped and the popularity of an event can explode. This result is described in further detail below in regards to the prediction formula.

7. Social Effectiveness of Active vs. Passive Expressions

As explained previously, expressions can be active or passive depending on whether the user has actively decided to generate an expression or if the system has automatically generated an expression based on a user's actions. For example, active expressions include a user specifically choosing a share link on a trivia question that they answered correctly. Alternatively, passive expressions include automatic social tracking messages that are sent to a user's Facebook® wall when they press play on a movie. By tracking the results of the number of new viewers that are generated by active and passive expressions, the effectiveness of active expressions are nearly ten times more effective than passive expressions. This means that it takes ten times more passive expressions to generate a new viewer than active expressions. Accordingly, the social media presentation system has a very big incentive to generate active expressions by users through the creation of more interactive and engaging content that will drive users to share their experiences with the reconfigured media inputs with their friends.

8. Graphical Depictions of Social Media Effectiveness Measurements

The social media effectiveness measurements may be displayed in multiple different configures and include graphical depictions of social media effectiveness and social engagement measurements for various products. For example, a graphical depiction may be provided that shows the size of a box that indicates the number of viewers, the boxes may be colored from green (good) to red (bad) for the product social marquee effectiveness of each product. Accordingly, a graphical representation of various products being offered by the reconfigured media provider may be displayed for a content provider at their request. Accordingly, user interactions may allow data to be collected and easily graphically analyzed in order to determine important aspects for the products being presented by the social media presentation system. Accordingly, similar reports regarding the social metrics of products, events, engagements, etc. may be generated and sent to content providers, artists, and any other entities associated with the products.

B. Social Productivity Measurement (SPM)

Another social engagement measurement is referred to as a social productivity measurement (SPM). The SPM (also referred to as a SPM productivity measurement) weighs interactions and indications of user engagement as being more valuable than raw number of fans, users, viewers, etc.

For example, if a product only has a small number of users viewing the product but the users are very actively interacting with the content generating numerous expressions and user interactions by answering lots of trivia questions, sending quotes and video clips to friends, sending chats to other users, etc., the product may have a higher SPM productivity measurement than a product that has many more users that are not actively interacting with the product.

For example, a SPM productivity measurement may include the sum of all users' interactions and expressions for a particular product. Further, the interactions and expressions may be given different points or weightings to ensure that more active and effective expressions (e.g., video clip, quote, and poll shares) have more of an impact on the SPM productivity measurement than less valuable interactions (e.g., visits, clicks, etc.). For example, a trivia interaction (click interaction) by a user may generate 2 points, a trivia expression (active expression) may generate 4 points, and a social tracking interaction may be worth 1 point.

An exemplary algorithm for determining a SPM productivity measurement is provided below:

$$SPM = \frac{( Users ) + ( Viewers * 1.5 ) + ( Interactions * 2 ) + ( Passive Expressions * 2.5 ) + ( Active Expressions * 5 )}{\# of Days Into Current Month} \qquad ( 6 )$$

Accordingly, the number of users, numbers of viewers, number of interactions, number of passive expressions, and number of active expressions may be weighted by different factors to measure the level of engagement that a product has based on the interactions and expressions of users. For example, a product that has 100 users but 1,000 expressions would have a much high SPM productivity measurement than a product that has 1,000 users but only 100 expressions. The denominator is the number of days that have elapsed in the current month and the number of users, viewers, interactions, and expressions is measured for that month. Any other method for measurement could also be applied that normalizes the time periods for the measurements (e.g., could be all expressions in last week divided by 7, or could use any other period of time, etc.). However, any potential weighting could be applied to change the SPM productivity measurement.

Further, a SPM productivity measurement scorecard may be generated based on the amount of interactive engagement a product has across its users and may rank the product based on user engagement. For example, a product with a small number of user orders as well as very few expressions and interactions may receive an F grade with a number of different columns or sub-categories being separately provided to quickly and easily show an operator, manager, or engineer which aspects of the media input are lacking in user engagement. Alternatively, a product with a large number of users associated with it but a small number of expressions and interactions may receive a C or a D grade. Further, a product with a small number of users but large amounts of interactions, expressions, and overall user interaction may receive a grade of an A or a B. Finally, a product with a large number of users and the users are actively engaged in the product leading to a large number of interactions and engagements may provide a letter grade of an A. Accordingly, the user interaction level of a product may quickly and easily be determined by embodiments of the present invention.

The SPM productivity measurement provides an accurate measurement of user interaction, which provides further insight into popularity, interest, and consumer demand then merely the number of users that are associated with a product. For example, a very popular character, celebrity, band, etc. may have a lot of mediocre or dis-interested fans while a less popular band with a cult following may have a lot fewer fans but fans that are willing to pay more money, provide more support, and are more interested in attending a concern than those fans of the more popular band. Accordingly, the SPM productivity measurement provides an engagement measurement that can provide useful insight into whether there is demand for a particular subject, media input, or event.

Accordingly, media companies, advertisers, and other entities are very interested in determining which products have devoted user bases that can support additional shows, products, or other additional media interaction.

Further, SPM may be used to compare the user engagement levels between different social media networks. For example, SPM may be calculated for a particular subject matter related to a media input (e.g., a movie or trailer) and the level of engagement of users associated with that subject matter may be calculated for each of the social media networks and compared to the SPM of the reconfigured media provider. For example, a SPM for Twitter™ may be calculated by measuring the number of tweets per follower of a particular media input. Further, a SPM for Facebook™ may be calculated by determining the number of users engaged (e.g., recently communicated about the subject matter, posted on the subject matter's wall, or otherwise engaged with the subject matter) with a particular subject matter divided by the number of users who are associated with the subject matter (e.g., liked a subject matter, follow a subject matter, etc.). Similar calculations may be made on any social media networks. The SPMs associated with each social media network and the reconfigured media provider may be displayed to compare the SPMs for each entity.

C. Universal Product Engagement Ratio

Another social engagement measurement includes a measurement of the universal engagement level surrounding a particular product, subject matter, or media input. A universal product engagement ratio (UPER) may be used to track the overall interest of users in a product or media input outside of the social media presentation system. The UPER may be determined by tracking a universal level of interest and engagement associated with the product, media input, or subject matter throughout the internet by designated fans of that subject matter.

For example, embodiments of the present invention may be able to determine how users are interacting with fan pages by aggregating chats and fan interest from other social media networks. Accordingly, the universal product engagement ratio may be determined by measuring the number of engaged fans divided by the number of fans generally. This measurement may provide an overall product engagement indicator of the passion or underlying level of interest of a fan base in the product.

$$UPER = \frac{Total No . of Engaged Fans}{Total No . of Fans} \qquad ( 7 )$$

The UPER is important because the number of fans or users that have supported a product in the past does not necessarily drive the success of a product event on the social media presentation system going forward. Instead, the important indicator for predicting and providing successful product events is the interaction or engagement level of the fan base. Accordingly, the general engagement level (i.e., level of passion) of a fan base outside of the social media presentation system is an important measurement for determining the overall success of events presented through the social media presentation system.

The product engagement ratio measurement can be applied anywhere, using any platform, and may measure a general activity level associated with a particular product. Measuring the number of engaged fans may be accomplished through a number of different manners and may depend on the type of social media network that is being used to determine the level of engagement. In some embodiments, more than one social media network may be used and in other embodiments, a single social media network may be used to gauge the level of interest.

First, the reconfigured media server determines the number of overall fans. Any suitable method may be used to determine the number of overall fans of a product, subject matter, or media input. For example, the reconfigured media provider may sum the number of users that have indicated that they are fans of a particular product through “liking” or otherwise endorsing a product or media input over multiple social media networks and then averaging by the number of social media networks that the user numbers were taken from. Another method is to add mailing lists, concert attendees, past event attendees, record sales, box office sales, or any other objective measure of the number of people interested in a subject matter or product (movie, band, etc.). Additionally, the reconfigured media provider may track the number of fans on a media's website, a mailing list, etc.

Next, the reconfigured media provider determines the number of engaged fans taking the sum of people who have “liked” or endorsed the fan page for a media input in the last seven days, have posted stories to the fan page of a social media network, or who have commented on stories that are posted.

Depending on the social media network, different methods for measuring the number of fans and the level of engagement may be made. For example, if the social media network is based on fan or subject matter pages or accounts such as Facebook®, the number of fans may be determined by looking at the number of likes or number of friends of the fan page. Further, the level of engagement may be measured through the number of comments, posts, likes, or other engagement measurements that have been made no that fan page over a short period of time (e.g., 1 week, 2 weeks, 1 month, etc.).

As another example, for social media networks that are based on messages being shared between followers (e.g. Twitter®), the overall number of fans may be determined by the number of followers of a fan account or accounts that are managed by a production company. In order to determine the level of engagement, a keyword search may be done on the subject matter and any new shares, tweets, or re-tweets of something related to the product could be summed to determine the overall interest level of the number of fans. For instance, using searches of messages (e.g., Tweets®) posted to the social media network (e.g., Twitter®), the reconfigured media provider may determine how many users have talked about a specific brand, band, movie, etc. versus how many followers that brand, band, movie, product, etc. has. Further, the measurement could be made continuously or periodically (e.g., every day, week, etc.) and the engagement level of fans could be plotted over time to see how fans react to particular releases, concerts, etc. Accordingly, embodiments of the present invention can track the current engagement level of each product.

This can be used to investigate the successfulness of marketing campaigns and in determining the most successful marketing avenues for generating users for the social media presentation system. For example, the reconfigured media provider may determine that marketing campaigns that implement Twitter® posting and responses to a particular marketing campaign are going to result in more successful engagement with a product.

D. Prediction Formulas

Using the measurements described above, multiple formulas may be developed that predict the size of an event by the number of orders (i.e., the number of users that may pay for or attend the event) through the social media presentation system as well as the “viralness” or chances that a media input is going to go “viral” (i.e., explode in popularity). Accordingly, the system can use the social marquee effectiveness ratio of a product to determine how many viewers are likely to attend an event, whether the product is likely to become a viral event (i.e., the measure of “virality” of a product), and can provide predictions regarding profitability, user interaction levels, user engagement, etc. of a product.

1. Predicting Number of Orders for Products or Events

Embodiments of the present invention may use a formula that may predict the number of users that will attend an event or purchase a product based on objective aspects surrounding the product or media input. For example, if the product is a movie premiere, the reconfigured media provider may be able to predict for a studio based on the day of week that the movie is being released, the time of day, the type of content, the number of fans you have, the fans engagement with the material, and any number of additional aspects, that the event is going to produce 10,000 viewers or orders.

Accordingly, the prediction formula may be able to pick different objective and subjective metrics surrounding the event and be able to predict the success of an event. Objective metrics may include, for example, the number of events the artist has, the number of platinum albums the band has, the number of blockbuster movies the actors have been in, etc. Subjective criteria may include, for example, the relevancy of the artist, movie director, lead actor, or the overall engagement level of a demographic that this artist appeals to (e.g., an artist may appeal to a younger crowd that inherently is more engaged with interactive content), etc.

Accordingly, the reconfigured media provider may approach content providers and provide predictions regarding the success of events and provide advice on how to improve such events. Therefore, the formula may be used to predict the success of one product over another and the factors that led to the more successful event.

Further, embodiments of the present invention may be used to identify trends surrounding user engagement and allow the reconfigured media provider to develop the most comprehensive and interactive experience for users. For example, after analyzing the data for multiple product events, certain objective criteria may be gathered and plotted to build relationships and trends between seemingly unrelated information.

2. Predicting Viral Events—Virality Threshold

Additionally, using the various measurements that are described above, the reconfigured media provider may also provide a prediction as to the degree of “virality” of a product or the chance that a product becomes a viral sensation. A virality threshold may be determined such that if a product reaches certain values in the prediction formula, the formula predicts that the content will become viral and thus interested users in the product will grow at an extremely high rate (e.g., exponentially).

Accordingly, embodiments of the present invention may measure the social connections between new viewers and tracking identifiers and may determine the social connectedness of new viewers to those originating the expression. Accordingly, the reconfigured media provider may determine when content is popular enough over multiple social groups that the content will become viral.

For example, if a product has an expression to new viewer ratio of ten to one and if the product social marquee effectiveness ratio for a particular media input is ten expressions to generate a new viewer, if users create five to ten expressions per visit, the prediction formula may enter the threshold viral level where the circumstances for the start of a viral event are present. Further, if users are creating twenty expressions every time they visit a product, every one person that goes in, creates two new viewers. Accordingly, each user may be able to obtain and sustain essential growth that leads to a viral event.

3. Method of Analyzing Collected Data and Generating a Prediction

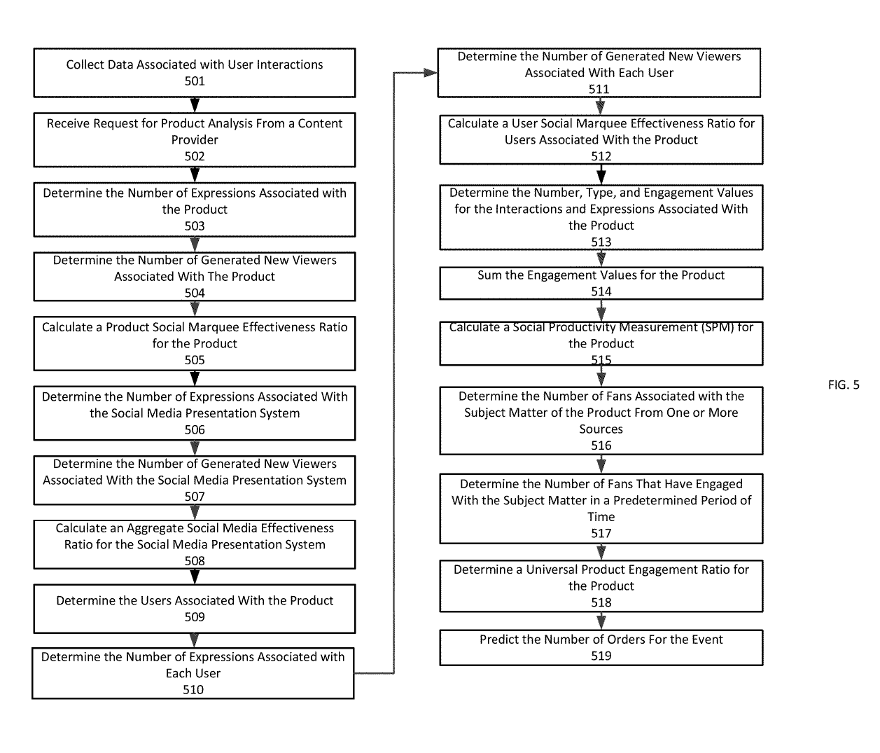

FIG. 5 shows a flowchart for analyzing collected user interactions related to a product to determine the social effectiveness and social engagement measurements related to the product, according to an exemplary embodiment of the invention.

At step 501, the reconfigured media provider collects data associated with user interactions. Any and all of the processes described above in relation to the collection of data in response to user interactions with engagements may be used to collect the data. User interactions data may be stored in an interactions database and may include references to product identifiers, studio identifiers, engagement identifiers, unique tracking identifiers, and any other relevant information in order to allow the system to quickly and easily query interactions data associated with any relevant variable of the system.

At step 502, the reconfigured media provider receives a request for a product analysis from a content provider. The content provider may desire to know the factors that are driving new viewers of their media inputs, may wish to determine the success of a particular media input, may wish to predict the success of a particular media input, or may have any interest in obtaining the social interaction metrics related to the product.

At step 503, the reconfigured media provider receives the request for a prediction and determines the number of expressions associated with a product. Accordingly, the reconfigured media provider server computer may determine the product identifier received in the content providers request, may search the interactions database for all expressions that are associated with the product identifier, and may sum the total number of expressions associated with the product. Further, any suitable method for determining the number of expressions may also be implemented. For example, the interactions database may comprise a variable for whether a user interaction is an expression (either passive or active) or an interaction. Alternatively, the search through the interactions database may comprise a search to determine the type of each user interaction and a counter may be implemented for the type of interaction based on the type of user interaction. For example, the interactions database may be searched for all user interactions associated with the product identifier and if a user interaction is a visit, a success, an authentication, or a click, the number of expressions may not be incremented. However, if the relevant user interactions are shares, likes, or social tracking expressions, then the counter may be incremented until all of the relevant user interactions have been analyzed and the type determined. Further, in some embodiments, the user interactions may be further filtered to only count active vs. passive expressions (e.g., shares and likes vs. social tracking expressions).

At step 504, the reconfigured media provider determines the number of generated new viewers associated with the product. Further, the interactions database may be searched for new viewer entries that are associated with the product identifier that is the subject of the search. The new viewer generated entries may include a user identifier that is responsible for the new viewer being driven to the reconfigured media provider (e.g., determined using the tracking identifier), a product identifier for the product that the user was driven to through the link, the user identifier for the new viewer, the engagement identifier that the new viewer interacted with, and any other relevant information. Accordingly, the interactions database may search new viewer entries associated with the product identifier and may increment a counter for each new viewer entry associated with the product identifier.

At step 505, the reconfigured media provider calculates a product social marquee effectiveness ratio for the product. The product social marquee effectiveness ratio is calculated by dividing the total number of expressions associated with the product identifier by the total number of new viewers associated with the product. As such, the reconfigured media provider may make the calculation and save the product social marquee effectiveness ratio for the product.

At step 506, the reconfigured media provider determines the number of expressions associated with the social media presentation system. As explained above in reference to determining the number of expressions associated with the product identifier, a similar process may be used to determine the number of expressions associated with the social media presentation system in general except the number of expressions may not be limited to a particular product identifier. Instead, all expressions generated by the social media presentation system may be calculated.

Further, note that for all of these calculations, a time limit may be implemented such that the results are relevant to the recent past. Accordingly, the total number of expressions for the social media presentation system may be limited to the period of time that the product has been offered through the system, by a particular time period (e.g., a month, week, etc.), by the number of elapsed days in the current month (e.g., on December 20^{th}, a December average expressions/day figure may be determined by normalizing the number of expressions by 20), or any other time limit may be implemented. However, the time limit may be normalized across the various calculations such that each of the figures calculated in the prediction formula are normalized in the same manner.

At step 507, the reconfigured media provider determines the number of generated new viewers associated with the social media presentation system. A similar process may be implemented as above but the new viewer entries may not be limited to those associated with the product identifier.

At step 508, the reconfigured media provider calculates an aggregate social media effectiveness ratio for the social media presentation system. The aggregate social media effectiveness ratio may be calculated by dividing the total number of expressions for the social media presentation system by the total number of new viewers for the same period. Accordingly, a system wide average social effectiveness may be determined for the social media presentation system.

At step 509, the reconfigured media provider determines the users associated with a product. The users may be identified by searching an order database for user identifiers associated with a product identifier associated with the product that is the subject of the search. Accordingly, the result may include a list of users that have ordered the product. This result may also be filtered or limited by a time frame (just as with the other calculations and data analysis).

At step 510, the reconfigured media provider determines the number of expressions associated with each user. The reconfigured media provider may determine the number of expressions associated with each user by analyzing the interactions database for each user identifier and keeping a counter for each user identifier of the number of expressions. This figure allows the reconfigured media provider to identify the interaction level of each user associated with the product that are interacting with the system or product identifier a lot. The number of expressions may be analyzed for the user identifier and the product identifier or just the user identifiers (e.g., the results may focus on users that have a lot of expressions for the particular product identifier or may look at general level of activity of users with the social media presentation system). In some embodiments, the most active users may be provided to the content provider which may allow the content provider or reconfigured media provider to target engagements, advertisements, and other related content to the product at the user.

At step 511, the reconfigured media provider determines the number of generated new viewers associated with each user. The number of generated new viewers may be determined similarly to the number of new viewers determined above in step 504 and 507 except the new viewer entries may be limited to those that were generated by the identified user identifiers from step 509. Accordingly, the system may determine the list of users that are driving the most new viewers to the product identifier or to the reconfigured media provider system generally.

At step 512, the reconfigured media provider calculates a user social marquee effectiveness ratio for users associated with the product. The user social marquee effectiveness ratio is calculated by dividing the number of expressions for each user associated with the product identifier by the total number of new viewers generated by each user associated with the product identifier. Accordingly, the most effective or the users with the most social clout per expression may be determined and they may be exported to the content provider for possible contact for sponsorship, partnership, or other interaction between the content provider and the important user.

At step 513, the reconfigured media provider determines the number, type, and engagement values for the interactions and expressions associated with the product. The reconfigured media provider may determine the number of engagement values for the interactions and expressions by searching the interactions database for all interactions and expressions associated with the product identifier. A counter for each type of interaction or expression may be kept and engagement values may be provided for each type of user interaction. For example, 1 point may be provided for all users associated with a product identifier, 2 points may be provided for each interaction related to product identifier, 3 points may be provided for each passive expression associated with the product identifier, and 5 points may be provided for each active expression.

At step 514, the reconfigured media provider sums the engagement values for the product. After all of the expression values are calculated, the values may be summed.

At step 515, the reconfigured media provider calculates a social productivity measurement (SPM) for the product. The social productivity measurement may be based on particular scoring criteria as described above and the scoring criteria may be altered at any time by the reconfigured media provider or content provider.

At step 516, the reconfigured media provider determines the number of fans associated with the subject matter of the product from one or more sources. The number of fans may be determined through any suitable method including identifying profile pages associated with the product identifier and the number of followers in a given time period or any other suitable process.

At step 517, the reconfigured media provider determines the number of fans that have engaged with the subject matter in a predetermined period of time. The number of active fans may be determined by looking for interactions with the content associated with product during a time frame. For example, fan messages posts, views, trend searches on search websites, and any other suitable methods may be implemented for determining the number of actively engaged fans.

At step 518, the reconfigured media provider determines a universal product engagement ratio for the product. The universal product engagement ratio for the product may be determined by dividing the number of actively involved fans by the total number of fans associated with the product.

At step 519, the reconfigured media provider predicts the number of orders for the event and provides the prediction to the content provider. The prediction may be implemented through any suitable algorithm and may be based on a weighting of all of the above calculated social interaction metrics, a regression analysis of previously similar social metrics and ultimate results, and any other suitable method. Accordingly, the reconfigured media provider may generate a prediction and send the predicted number of viewers to the content provider in response to the content providers' request. The reconfigured media provider may also provide the underlying data, star user identifiers along with contact information, and any other relevant information.

### V. ACTIONS TAKEN IN RESPONSE TO DATA ANALYSIS

Finally, using the measurements, predictions, and analysis described above, embodiments of the present invention may provide advice and actions that a media provider may implement to generate the most successful event possible.

For example, an optimization algorithm may be used to determine the most beneficial criteria that will lead to the most users. For example, the reconfigured media provider may determine that an event should be delayed until a video game related to the event is released because the user engagement surrounding the video game may result in 3,000 more viewers. Additionally, the length, quality of engagements within each product, surrounding engagement features and advertising may all be optimized using the formula to determine the best possible engagement.

Furthermore, some embodiments of the present invention may provide an event scorecard that provides a current engagement score and quickly and easily provide advice regarding how the event can be improved. The scorecard may be used to modify or develop future events including the type of events that are generated and the attributes of such events.

For example, the system may determine that the five users with the highest user social marquee effectiveness ratios may have a hand in developing the event and may be approached regarding helping to market the event to other users. Accordingly, the reconfigured media provider may identify these users that are in that genre that are going to push content, may generate automatic contact with these users through the platform, and may increase the success of the event by partnering with these users.

A. Optimization Formula

According to some embodiments, a reconfigured media provider may develop an optimization algorithm to optimize an event in order to achieve the highest number of possible orders. The optimization algorithm may be based on event information (e.g., event time, type, whether live or on-demand, level of interactivity, whether a celebrity is present, etc.), the social effectiveness measurements (e.g., user, product, and aggregate social marquee effectiveness ratio), and the social engagement measurements (e.g., SPM productivity measurement and Universal Product Engagement Ratio) to determine how an event or product may be improved.

Based on the vast number of events that the reconfigured media provider has organized and monitored through the social media input player, the reconfigured media provider may be able to determine which event characteristics drive user attendance and increase the number of orders. Accordingly, an algorithm may be used to analyze an event and provide recommendations for increasing the number of orders.

For example, the reconfigured media provider may determine that having users with social clout advertise for an event drives a lot of users to an event. Accordingly, the reconfigured media provider may automatically contact these users and provide a commission for every new viewer the user can drive to the event. Further, the event information including time, date, whether a celebrity is moderating the event, whether the event is live or on-demand, may also greatly impact attendance. As such, the optimization formula may provide recommendations that the event be changed from an on-demand event on a Wednesday afternoon to a live streaming event with a celebrity moderator on a Friday evening. Further, the optimization formula may provide an optimization result evaluating the number of increased users that may attend if the recommendations are adopted.

Accordingly, embodiments of the present invention may analyze event information and provide seamless and automatic recommendations for increasing the number of orders and ultimately, the success of an event based on the social measurements and event information described above.

B. Event Scorecards

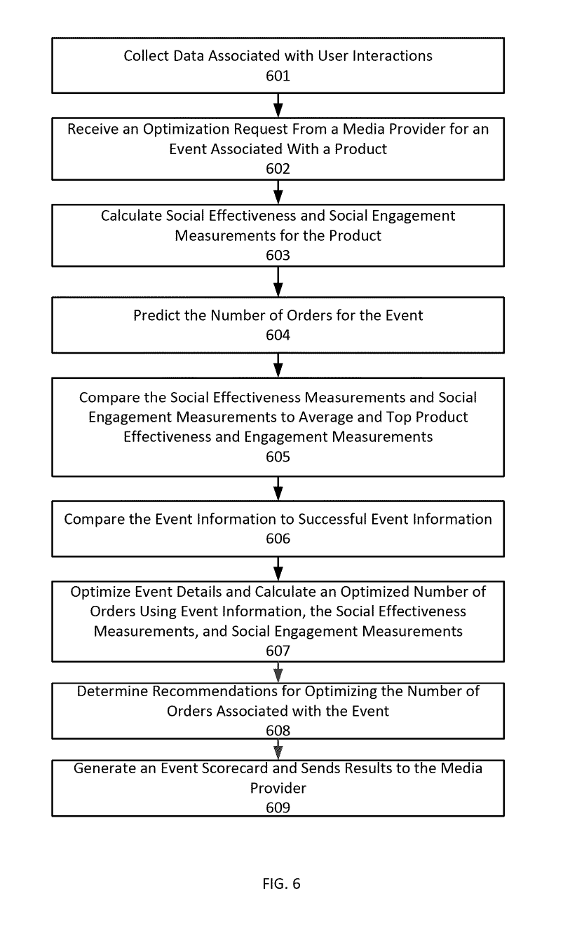

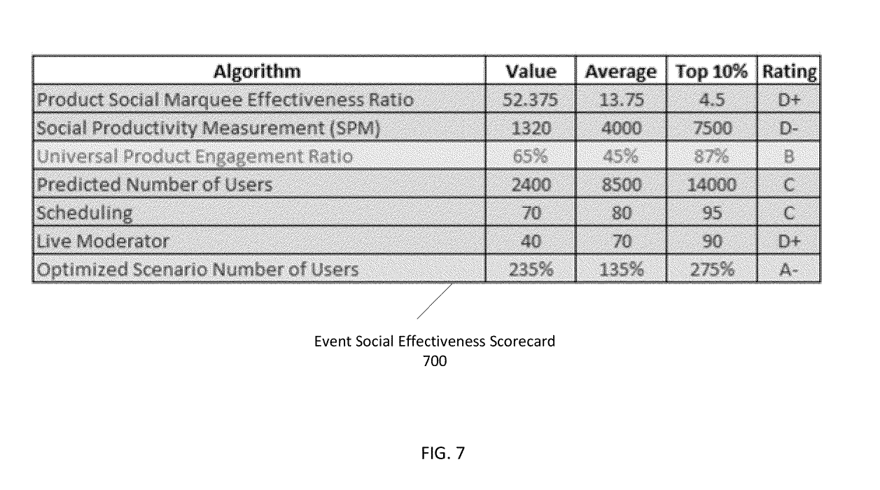

FIG. 6 shows a method of generating an event scorecard, according to an embodiment of the present invention and FIG. 7 illustrates an exemplary event scorecard generated by FIG. 6. In some embodiments, an event scorecard may be generated based on the social engagement measurements of an event, product, or media input that is hosted by the reconfigured media provider.

At step 601, the reconfigured media provider may collect data associated with user interactions. The reconfigured media provider may collect data associated with user interactions using any and all of the methods described herein.

At step 602, the reconfigured media provider receives an optimization request from a media provider for an event associated with a product. The optimization request may include a number of variables for the media event (e.g., date, time, previous number of viewers or attendees at similar events, etc.) or may merely include a product identifier.

At step 603, the reconfigured media provider calculates a social effectiveness and social engagement measurements associated with the product. The steps and details regarding calculating the social effectiveness and social engagement measurements may be found above in relation to FIG. 5.

At step 604, the reconfigured media provider predicts the number of orders for the event. Similarly, the prediction may be calculated as with the method described in FIG. 5, where any suitable method of predicting results may be implemented and the social effectiveness measurements may be used to predict the results.

At step 605, the reconfigured media provider compares the social effectiveness measurements and social engagement measurements to average and top product effectiveness and engagement measurements. The reconfigured media provider may have an event database that further comprises past event results and allows the system to determine where social metrics are and what the average, top 10%, and lower 10% of events over the social media presentation systems history stack up. Accordingly, the values may be determined from the database or may be calculated at the time of the optimization process.

At step 606, the reconfigured media provider compares the event information to successful event information. The event information is obtained from the optimization request or from event information associated with the product identifier and comprises information such as date, time, whether a live actor will live blog the event through the social media presentation system, and any other information related to the event that is not captured by the reconfigured media system.

At step 607, the reconfigured media provider optimizes event details and calculates an optimized number of orders using event information, the social effectiveness measurements, and social engagement measurements. Any suitable optimization algorithm may be used including a regression analysis, comparisons to historically successful and unsuccessful events, and any other suitable methods. Any suitable method of displaying the optimization results that show the possible number of users that could possibly be expected if any and all aspects of the event were changed to the best possible scenario may be provided. For example, FIG. 7 shows the optimization results in a percentage increase format over the original expected number of viewers. The total number of viewers, a grading system, or any other suitable method of displaying the optimization data may be used.

At step 608, the reconfigured media provider determines recommendations for optimizing the number of orders associated with the event. Accordingly, the recommendations may be provided in the scorecard or in a related communication, report, or through any other suitable method.

At step 609, the reconfigured media provider generates an event scorecard and sends results to the media provider including the optimization results and recommendations. The quality, difficultly, and interest level of the engagements can influence the engagement level of users. A product that is more productive may have a higher SPM because the users are more engaged with the product and the users drive other users to interact with the event.

Accordingly, it may be beneficial to quickly and easily inform a media provider of how and why an event is predicted to be a success or failure. FIG. 7 shows an exemplary transaction scorecard, according to one embodiment of the present invention. The scorecard may provide separate metrics, grades, and information for each of the social metrics that are determined by the social media presentation system and each metric that is used in the optimization calculation. Additionally, the scorecard may provide color guides on whether the results are positive or negative in light of the average event provided through the system. Further, an average and top or bottom 10% (or any other percentage amount) may be provided in the scorecard in order to provide as much information about how the event metrics and details match up against historical events and intuitively provide insight into how the optimization and predictions are being calculated.

Additionally, the scorecards can provide information based on the average and top events provided by the reconfigured media provider. Further, the scorecard can provide grades for each type social measurement provided by the system to show the media provider where they can improve on a visual basis. Accordingly, media providers can quickly and easily see how they stack up against average and top events and see how their attendance or orders may be affected if they take the recommendations of the optimization formula. Furthermore, reconfigured media providers may automatically make the recommended changes and optimize events, reconfigured media inputs, advertisements, and any other information based on the optimization and prediction methods disclosed herein.

C. Targeted Engagements and Advertisements

Additionally, embodiments of the present invention may use the collected data received through the methods described in section I and II above, in order to target users for specific engagements, advertisements, and other information based on their previous actions. Accordingly, using the social metrics determined above and/or a regression analysis on the collected interaction data for each user, in some embodiments, a different set of engagements and/or targeted engagements may be provided to a user that are tailored for that users' interests, experience, etc.

For example, a user's gender may be determined and particular engagements may be directed to the user based on the user's gender. Further, more complex analysis may be used as well. For example, a regression analysis may be applied to a user profile before or while a reconfigured media input is being provided to them, and different sets of engagement data may be delivered to the user computer based on the regression analysis based on the data collected as described above.

For example, if a user has a lot of expressions related to a particular sport, movie genre, etc., a regression analysis may be performed to identify that the user would most likely enjoy a similar movie, clip, quote, or other engagement. Accordingly, the reconfigured media provider server computer may select the engagement data that is most likely to match the user's interests and sends that engagement data to the user computer to be displayed during playback of a reconfigured media input. The regression analysis may be performed at any time and may be pre-processed such that no delay is experienced by the user. Accordingly, for each media input provided by the reconfigured media provider, multiple sets of engagement data may be generated and stored for different types of users, for each particular registered user, or different engagements may be selected from a general number of engagements based on analysis of the users or all users interests and previous activities, interactions, etc.

### VI. COMPUTER SYSTEM

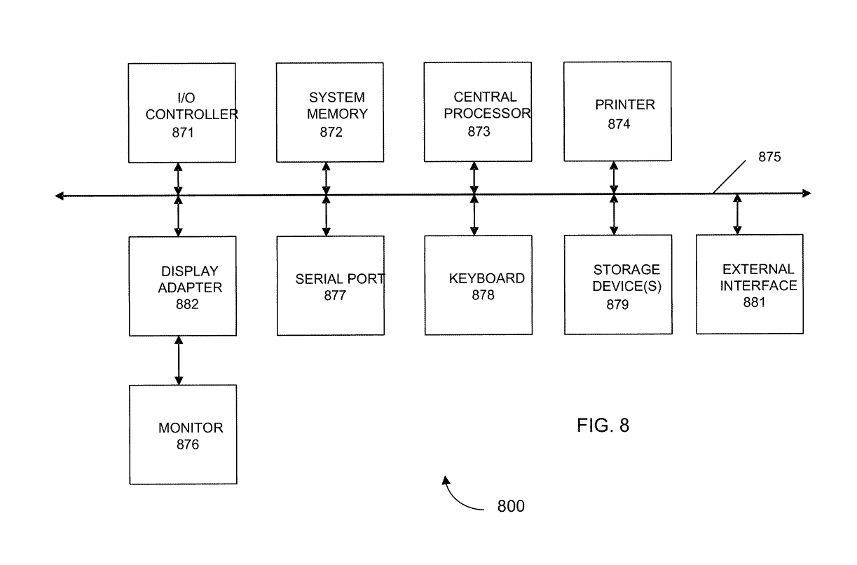

The various participants and elements shown in FIG. 2 may operate one or more computer apparatuses (e.g., a server computer) to facilitate the functions described herein. Any of the elements in FIG. 2 may use any suitable number of subsystems to facilitate the functions described herein. Examples of such subsystems or components are shown in FIG. 8. The subsystems such as a printer 874, keyboard 878, storage device 879 (or other memory comprising computer readable media), monitor 876, which is coupled to a display adapter 882, and others are shown. Peripherals and input/output (I/O) devices, which couple to I/O controller 802, can be connected to the computer system by any number of means known in the art, such as serial port 877. For example, serial port 877 or external interface 881 can be used to connect the computer apparatus to a wide area network such as the Internet, a mouse input device, or a scanner. The interconnection via system bus 875 allows the central processor 873 to communicate with each subsystem and to control the execution of instructions from system memory 872 or the storage device 879, as well as the exchange of information between subsystems.

Specific details regarding some of the above-described aspects are provided below. The specific details of the specific aspects may be combined in any suitable manner without departing from the spirit and scope of embodiments of the invention.

Storage media and computer readable media for containing code, or portions of code, may include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which may be used to store or transmit the desired information and which may be accessed by the computer. Based on the disclosure and teachings provided herein, a person of ordinary skill in the art may appreciate other ways and/or methods to implement the various embodiments.

It should be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention should, therefore, be determined not with reference to the above description, but instead should be determined with reference to the pending claims along with their full scope or equivalents.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A method of providing an event scorecard, the method comprising:
receiving, by a server computer, a user interaction from a user computer;
determining, by the server computer, an engagement associated with the user interaction;
identifying, by the server computer, a type of user interaction for the received user interaction, wherein the type of user interaction includes one of an interaction type or an expression type;
determining, by the server computer, a user identifier associated with the user interaction;
storing, by the server computer, information associated with the user interaction including the user identifier, the type of user interaction, and a product identifier;
determining, by the server computer, a social engagement level for a product associated with an event based on stored user interactions;
generating, by the server computer, event scorecard ratings based on the social engagement level; and
displaying an event scorecard including the event scorecard ratings for the event.

2. The method of claim 1, wherein identifying the type of user interaction for the received user interaction further includes:
determining the user interaction is of the expression type of user interaction where the user interaction includes a request to share information with a server computer operated by a social media network; and
determining the user interaction is of the interaction type of user interaction where the received user interaction does not include a request to share information with a social media network.

3. The method of claim 1, wherein the user interaction is generated in response to a user interacting with the web browser operating or a mobile application on the user computer.

4. The method of claim 1, further comprising:
receiving, by the server computer, a plurality of communications including a plurality of tracking identifiers from a plurality of new viewers;
registering, by the server computer, the plurality of new viewers;
determining, by the server computer, the plurality of user identifiers associated with the plurality of tracking identifiers; and
storing, by the server computer, a plurality of generated new viewer values associated with the plurality of user identifiers.

5. The method of claim 1, further comprising:
if the user interaction is of the expression type of user interaction, generating a sharing communication including a tracking identifier;
sending, by the server computer, the sharing communication to another server computer;
receiving, by the server computer, a second user interaction from a new viewer including the tracking identifier;
determining, by the server computer, the user identifier associated with the tracking identifier; and
storing, by the server computer, a generated new viewer database entry associated with the user identifier.

6. The method of claim 5, wherein the method further comprises:
determining, by the server computer, a social separation value between the user and the new viewer; and
storing, by the server computer, the social separation value associated with the user identifier.

7. The method of claim 1, wherein determining the social engagement level for the product associated with the event based on stored user interactions further comprises:
determining a social marquee effectiveness ratio for the product; and
determining a universal product engagement ratio for the product.

8. The method of claim 1, wherein determining the social engagement level for the product associated with the event based on stored user interactions further comprises:
determining the number, type, and engagement values for a plurality of user interactions associated with the product;
summing the engagement values for the plurality of user interactions;
determining the number of users associated with the product; and
calculating the social productivity measurement associated with the product by dividing the summed engagement values with the determined number of users.

9. A method of providing an event scorecard, the method comprising:
tracking, by a server computer, user interactions with a product;
determining, by the server computer, a social effectiveness of the product associated with the event based on the number of new viewers associated with the product;
determining, by the server computer, a user product engagement level associated with the product;
determining, by the server computer, a universal product engagement level associated with the product;
predicting, by the server computer, a number of orders associated with the event based on event information, the social effectiveness of the product, and the user product engagement level;
calculating, by the server computer, an optimized number of orders using event information, the social effectiveness, the user product engagement level, and the universal product engagement level associated with the product;
determining, by the server computer, recommendations for optimizing the predicted number of orders associated with the event; and
displaying, by the server computer, the event scorecard including the recommendations for optimizing the number of orders associated with the event.

10. The method of claim 9, further comprising determining the social effectiveness of a user by:
determining a number of expressions associated with the user identifier;
determining a number of generated new viewers associated with the user identifier; and
dividing the number of expressions by the number of generated new viewers.

11. The method of claim 10, further comprising:
comparing the social effectiveness of the user to a predetermined influencer threshold; and
updating a profile associated with the user identifier to indicate they are an influencer where the social effectiveness of the user is over the predetermined influencer threshold.

12. The method of claim 11, further comprising:
determining one or more influencers associated with the event; and
displaying user identifiers associated with the determined one or more influencers in the event scorecard.

13. The method of claim 9, further comprising determining the average social effectiveness of a social media presentation system by:
determining a number of expressions associated with a plurality of active user identifiers for the social media presentation system;
determining a number of generated new viewers associated with the plurality of user identifiers; and
dividing the number of expressions by the number of generated new viewers.

14. The method of claim 9, further comprising determining the engagement level of a product, wherein determining the engagement level of a product comprises:
determining a number of engaged users for the product;
determining a number of fans associated with the product; and
dividing the number of engaged users for the product by the number of users associated with the product.

15. The method of claim 9, further comprising:
determining the user product engagement level associated with the product, wherein determining the user product engagement level further comprises:
determining user identifiers associated with the product;
determining user interactions associated with the user identifiers;
determining engagement objects associated with the user interactions;
based on the determined engagement objects, providing an engagement point value for each of the user interactions;
summing the engagement point values to determine a product engagement point value; and
dividing the product engagement point value by a number of user identifiers; and
including the user product engagement level associated with the product in the displayed event scorecard.

16. A method of providing an event scorecard, the method comprising:
tracking, by a server computer, user interactions with a product;
determining, by the server computer, a social engagement level for a product associated with an event;
calculating, by the server computer, an optimized number of orders using the social engagement level for the product;
determining, by the server computer, recommendations for optimizing the number of orders associated with the event; and
displaying the event scorecard including the recommendations for optimizing the number of orders associated with the event.

17. The method of claim 16, wherein calculating an optimized number of orders using the social engagement level for the product further comprises:
comparing the social engagement level for the product to an average social engagement level;
comparing the social engagement level for the product to top social engagement levels;
comparing event information associated with the event to successful event information; and
predicting the number of orders based on the comparisons of the engagement level and event information of successful events, average products, and top products.

18. The method of claim 17, wherein determining recommendations for optimizing the number of orders associated with the event further comprises:
identifying differences between the event information and the successful event information determined during the comparison; and
identifying one or more influencers associated with the product or the event.

19. A computer readable medium comprising code, executable by a processor, for performing the method of claim 1.

20. A server computer comprising:
a processor; and
the computer readable medium of claim 19.
